(19) United States
(12) Patent Application Publication
(10) Pub. No.: US 2025/0322242 A1
(43) Pub. Date: Oct. 16, 2025

(54) GENERATING TRAINING DATA WITH DISTILLED DOMAIN-SPECIFIC KNOWLEDGE TO FINE-TUNE DOMAIN-SPECIFIC LARGE LANGUAGE MODEL

(71) Applicant: Microsoft Technology Licensing, LLC, Redmond, WA (US)

(72) Inventor: Saurabh Gupta, Bellevue, WA (US)

(21) Appl. No.: 18/632,625

(22) Filed: Apr. 11, 2024

(51) Int. Cl. G06N 3/0895

(52) U.S. Cl. CPC G06N 3/0895

(57) ABSTRACT

Embodiments of the disclosed technologies are capable of generating an input of a set of input-output pairs using a first large language model (LLM) and a domain-specific training content. The set of input-output pairs is used to train a second LLM during supervised learning to perform a downstream task. The embodiments describe generating an output corresponding to the input of the set of input-output pairs using the first LLM and the domain-specific training content. The output includes reasoning by the first LLM contributing to the performing of the downstream task. The embodiments further describe training the second LLM to perform the downstream task using the set of input-output pairs and the reasoning.

### TECHNICAL FIELD

Embodiments of the invention relate to the technical fields of fine-tuning domain-specific large language models.

### BACKGROUND

Large language models can include billions of hyperparameters that allow large language models to perform natural language processing tasks. Training large language models requires significant computing resources and training data.

### BRIEF DESCRIPTION OF THE DRAWINGS

The invention may best be understood by referring to the following description and accompanying drawings that are used to illustrate embodiments of the invention. In the drawings:

FIG. 1 is a flow diagram of an example method for training a machine learning model using a training manager of a computing system, in accordance with some embodiments of the present disclosure.

FIG. 2 is an example flow diagram for generating training data for a classification task, in accordance with some embodiments of the present disclosure.

FIG. 3 is an example flow diagram for generating training data for an extraction task, in accordance with some embodiments of the present disclosure.

FIG. 4 is an example flow diagram for generating training data for a question-and-answer task, in accordance with some embodiments of the present disclosure.

FIG. 5 is an example flow diagram for generating training data for a summarization task, in accordance with some embodiments of the present disclosure.

FIG. 6 is an example method for fine-tuning a large language model, in accordance with some embodiments of the present disclosure.

FIG. 7 is a block diagram of a computing system that includes a training manager, in accordance with some embodiments of the present disclosure.

FIG. 8 is a flow diagram of an example method for training a large language model using generated training data, in accordance with some embodiments of the present disclosure.

FIG. 9 is a block diagram of an example computer system including a training manager, in accordance with some embodiments of the present disclosure.

### DETAILED DESCRIPTION

There are many different types of machine learning models that can be used to solve a problem. For example, generative models use artificial intelligence technology, e.g., neural networks, to machine-generate new digital content based on model inputs and the previously existing data with which the model has been trained. Whereas discriminative models are based on conditional probabilities P (y|x), that is, the probability of an output y given an input x (e.g., is this a photo of a dog?), generative models capture joint probabilities P (x, y), that is, the likelihood of x and y occurring together (e.g., given this photo of a dog and an unknown person, what is the likelihood that the person is the dog's owner, Sam?). A generative language model is a particular type of generative model that generates new text in response to model input. A large language model (LLM) is a type of generative language model that is trained using an abundance of data (e.g., publicly available data) such that billions of hyperparameters that define the LLM are used to iteratively develop statistical correlations that enable the performance of a task.

LLMs are trained to perform tasks by relying on patterns and inferences learned from training data, without requiring explicit instructions to perform the tasks. For example, LLMs predict a next token of a block of text. In operation, LLMs track relationships in sequential data by receiving tokens (e.g., words in a sentence) and predicting a next token (or sequence of tokens). As such, LLMs are able to mimic human language by generating responses that are coherent and contextualized. These models are well suited to perform different tasks such as form conversations (e.g., taking turns asking questions and providing responses), summarize information, classify data, or extract information, by predicting tokens (or sequences of tokens). After selecting a type of machine learning model to solve the problem, a developer or other administrator determines whether an open-source or generalized machine learning model should be implemented to solve the problem, or whether a specialized machine learning model should be implemented to solve the problem. Open-source machine learning models generally have large architectures and are pretrained with publicly available data (e.g., domain-neutral data) such that the open-source machine learning models iteratively develop statistical correlations used to perform a diverse range of tasks. However, given the size of such models, there may be delays associated with performing any task of the diverse range of task. In contrast, specialized machine learning models can have architectures smaller than the large architectures of open-source machine learning models (e.g., have fewer parameters than the open-source machine learning model), and therefore are encoded with less pretrained information. As a result, smaller models perform fewer tasks, but the tasks may be specialized, and the specialized machine learning model may be faster at performing the tasks. Accordingly, a developer or other administrator balances the need of a LLM to perform a diverse range of generalized tasks versus a smaller set of specialized tasks.

Additionally, the developer balances the environment in which the LLM is to be implemented (e.g., a specialized environment or a general environment). For example, generalized pretrained machine learning models can be well suited to perform various domain-neutral tasks (e.g., tasks learned using widely available or public data), but applying domain-specific data to such machine learning models can cause a drop of the machine learning model's performance. For example, a machine learning model is less suited to perform text summarization of a domain-specific text if the machine learning model has not been trained to summarize text using domain-specific language. Accordingly, selecting the machine learning model (e.g., a pretrained model or a specialized model) to perform a set of tasks can be technically challenging.

Fine-tuning, as used herein may refer to a mechanism of adjusting the parameters of the machine learning model that has been previously trained (e.g., pretrained), and then tuning the pretrained machine learning model to perform a new or different task. For example, a machine learning model trained to perform text summarization using domain-neutral data can be fine-tuned to perform domain-specific text summarization using domain-specific data.

Supervised learning is a method of training (or fine-tuning) a machine learning model, such as an LLM, given input-output pairs. An input-output pair is an input with an associated known output (e.g., an expected output, a labeled output, a ground truth). During a training period, a machine learning model iteratively develops statistical correlations used to perform a task, such as a natural language processing (NLP) task, by receiving training samples included as a training input. The machine learning model then predicts an output, by identifying one or more values with the highest confidence scores or probabilities, related to the task to be learned and compares the predicted output to the known output associated with the training input (e.g., the output of the input-output pair). Over time, (e.g., a number of training iterations), an error based on the difference between the predicted output and the known output decreases.

During fine-tuning, the machine learning model encodes domain-specific information such as vocabulary. Accordingly, the fine-tuned model is more familiar with the domain-specific data (e.g., vocabulary) and the accuracy of performing a task in a domain-specific environment increases. However, sometimes there is not enough training data to fine-tune the model. Training or fine-tuning the machine learning model to perform a target task requires large amounts of training samples (including training inputs and associated known outputs). Collecting such training samples can be time consuming, costly, and error prone. For example, in some conventional approaches, hundreds of thousands of training samples (e.g., input-output pairs) are used to train the machine learning model. If there is not enough training data, then the machine learning model does not develop the statistical correlations to encode domain-specific information.

The input to a LLM (both a training input or an input used during deployment of the LLM) includes a task description, also referred to as a prompt. A prompt can be in the form of natural language text, such as a question or a statement, and can include non-text forms of content, such as digital imagery and/or digital audio. The prompt can include instructions and/or examples of content used to explain the task that the LLM is to perform. Modifying the instructions, examples, content, and/or structure of the prompt causes modifications to the output of the LLM. For example, changing the instructions included in the prompt causes changes to the generated content determined by the LLM.

Prompt engineering is a technique used to optimize the structure and/or content of the prompt input to the LLM. Some prompts can include examples of outputs to be generated by the LLM (e.g., few-shot prompts), while other prompts can include no examples of outputs to be generated by the LLM (e.g., zero-shot prompts). Chain of thought prompting is a prompt engineering technique where the prompt includes a request that the LLM explain reasoning in the output. For example, the LLM performs the task provided in the prompt using intermediate steps where the generative model explains the reasoning as to why it is performing each step.

Crafting the prompts used by the generative model can be technically challenging. For example, determining what information to include the in prompt and how to convey the information in the prompt is directly related to how the LLM performs its target task.

Implementations of the described approaches train a domain-specific machine learning model to perform a set of domain-specific tasks by distilling domain-specific knowledge from a generalized pretrained machine learning model. In other words, domain-specific knowledge is transferred from the generalized pretrained machine learning model to a specialized machine learning model. In this manner, the specialized machine learning model is fine tuned to perform domain-specific tasks while also encoding domain-specific knowledge associated with the domain-specific tasks distilled from the generalized pretrained machine learning model. The specialized machine learning model can perform domain-specific tasks faster than a generalized pretrained machine learning model in part, because of the specialized machine learning model's smaller architecture, allowing the specialized machine learning model to perform tasks with reduced delay as compared to the generalized pretrained machine learning model's performance of tasks. Additionally, the specialized machine learning model can perform domain-specific tasks more accurately than a generalized pretrained machine learning model in part, because of the training data generated using domain-specific training content via the generalized pretrained machine learning model.

Implementations of the described approaches use a generalized pretrained machine learning model to generate both inputs and outputs of in-output pairs (e.g., training data) used in supervised learning to fine-tune a specialized model to perform a set of specialized tasks. Because the generalized pretrained machine learning model generates both inputs and outputs of the input-output pairs, the burden of obtaining training data is reduced. For example, given a domain-specific document, the generalized pretrained machine learning model generates an input that is dependent on a downstream task and also generates the corresponding output associated with the input. As a result, resources associated with obtaining training data (e.g., human resources associated with manually reviewing and/or annotating training data; financial resources associated with paying humans to manually review training data; computing resources associated with prolonged manual review of training data) are reduced.

Additionally, the generation of the training input shifts the burden of crafting the prompt from a developer to the generalized pretrained machine learning model. For example, the way in which the training data (e.g., the input-output pairs) is generated depends on the downstream task and the domain-specific knowledge encoded by the generalized pretrained machine learning model. As a result, the input-output pairs are implicitly injected with any domain-specific knowledge distilled from the generalized pretrained machine learning model, making the generated training data both specific to the downstream task and domain-specific.

Further, in some conventional systems, multiple machine learning models are each trained to perform a different domain-specific task. For example, in some conventional systems, a first machine learning model is trained to perform a task such as extract a content type from domain-specific content items. For instance, the conventional first machine learning model extracts job titles of users from resumes, articles, and job postings. In the same example, a second machine learning model is trained to perform a second task such as classify entities in domain-specific content items. For example, the conventional second machine learning model classifies user skills, user information, company information, and the like from resumes, articles, and job postings. Embodiments of the technologies described herein can avoid the need to deploy multiple separately trained models by using a single machine learning model that has been trained to perform multiple domain-specific tasks using targeted training data generation. In this manner, computing resources associated with deploying multiple machine learning models are reduced. For example, instead of deploying two machine learning models, as in the above-described example of a conventional system, embodiments deploy a single machine learning model with two adaptation components.

Embodiments of the technologies described herein include a two-stage pipeline used to fine-tune a machine leaning model to a domain-specific environment. In the first stage of the training pipeline, a first machine learning model generates targeted training data based on a domain-specific downstream task, reducing the time, cost, and human error associated with manually determining input-output pairs. The first machine learning model is provided unlabeled content items and an indication of a particular downstream task.

In the second stage of the training pipeline, a second machine learning model is instruction tuned (or fine-tuned) to perform multiple domain-specific tasks using the generated training data. In some embodiments, adaptation components are trained to perform a domain-specific task using a parameter efficient low rank representation of the pretrained weights of the pretrained machine learning model.

The disclosure will be understood more fully from the detailed description given below, which references the accompanying drawings. The detailed description of the drawings is for explanation and understanding and should not be taken to limit the disclosure to the specific embodiments described.

In the drawings and the following description, references may be made to components that have the same name but different reference numbers in different figures. The use of different reference numbers in different figures indicates that the components having the same name can represent the same embodiment or different embodiments of the same component. For example, components with the same name but different reference numbers in different figures can have the same or similar functionality such that a description of one of those components with respect to one drawing can apply to other components with the same name in other drawings, in some embodiments.

Also, in the drawings and the following description, components shown and described in connection with some embodiments can be used with or incorporated into other embodiments. For example, a component illustrated in a certain drawing is not limited to use in connection with the embodiment to which the drawing pertains but can be used with or incorporated into other embodiments, including embodiments shown in other drawings.

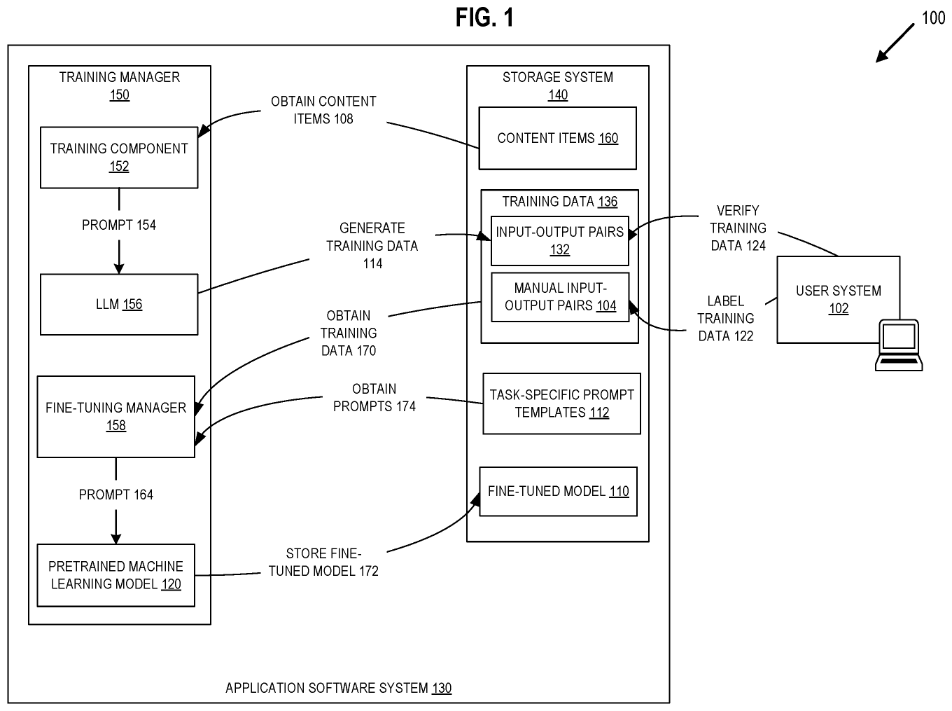

FIG. 1 is a flow diagram of an example method for training a machine learning model using a training manager of a computing system, in accordance with some embodiments of the present disclosure.

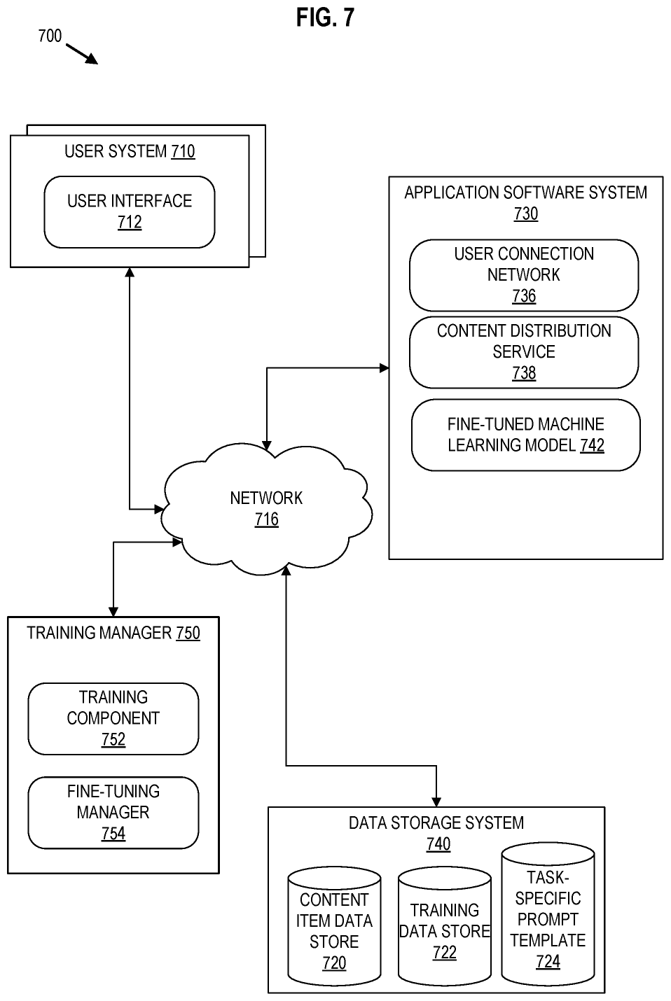

The method is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by components of a training manager 750 of FIG. 7, including, in some embodiments, components shown in FIG. 7 that may not be specifically shown in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

In the example of FIG. 1, computing system 100 includes a user system 102, an application software system 130, a training manager 150, and a storage system 140. The storage system 140 stores content items 160, training data 136, and fine-tuned model 110. The training manager 150 includes a training component 152, a large language model (LLM) 156, a fine-tuning manager 158, and a pretrained machine learning model 120.

As indicated in FIG. 1, components of computing system 100 are distributed across multiple different computing devices, e.g., one or more client devices, application servers, web servers, and/or database servers, connected via a network, in some implementations. In the example of FIG. 1, the components of the training manager 150 are implemented using an application server or server cluster, which can include a secure environment (e.g., secure enclave, encryption system, etc.) for the processing of search query data.

User system 102 includes at least one computing device, such as a personal computing device, a server, a mobile computing device, or a smart appliance. User system 102 includes at least one software application, enabling the user system 102 to bidirectionally communicate with the application software system 130. Additionally, the user system 102 can include a user interface that allows a user to label training data 122 such as creating manual input-output pairs 104. Each of the manual input-output pairs 104 are related to a task to be learned by the fine-tuned model 110. For example, an input can include a domain-specific document (e.g., a resume) and a first instruction for a domain-specific task (e.g., classify the technical skills included in the resume). The output corresponding to the input could include one or more labels of technical skills identified from the document (e.g., coding in Python). Additionally or alternatively, the input can include a domain-specific document (e.g., a job description) and a second instruction for a domain-specific task (e.g., a question-and-answer task that asks whether a candidate user is a good fit for the job post in the job description). The output corresponding to the input could include an answer to the question with associated reasoning for the answer.

The user system 102 can also verify training data 124 by verifying the input-output pairs 132 generated by the LLM 156, described herein. For example, one or more users of the user system 102 can read an input and verify that the determined output associated with the input is accurate. For instance, if the input is a resume and the output is supposed to be extracted text pertaining to the contact information included in the resume, a user using the user system 102 verifies that the extracted text is the contact information included in the resume.

In some embodiments, an output of the input-output pairs 132 generated by the LLM 156 include reasoning, or a natural language description of the output task determined by the LLM 156 corresponding to the input. For example, the reasoning of the output of the input-output pairs can include a natural language description of why or how an answer (e.g., an output generated by the LLM 156) relates to or otherwise addresses a question (e.g., an input generated by the LLM 156). In these embodiments, verifying the training data 124 can include verifying the reasoning generated by the LLM 156.

Application software system 130 is any type of application software system that provides or enables at least one form of digital content distribution of content items 160 to user systems such as user system 102. Examples of application software system 130 include but are not limited to connections network software, such as social media platforms, and systems that are or are not based on connections network software, such as general-purpose search engines, job search software, recruiter search software, sales assistance software, content distribution software, learning and education software, or any combination of any of the foregoing. Content items 160 include any digital content provided by the application software system 130 that can be displayed using to the user using the user system 102. For example, content items 160 can include digital content such as articles, job posting, blogs, user profiles, etc. In some embodiments, content items 160 include unstructured data. Unstructured data includes files stored without metadata or a predetermined format such as free-form text (e.g., one or more words, phrases, or sentences). In some embodiments, content items 160 include structured data. Structured data is data in a predetermined format (e.g., JSON format, bullet points).

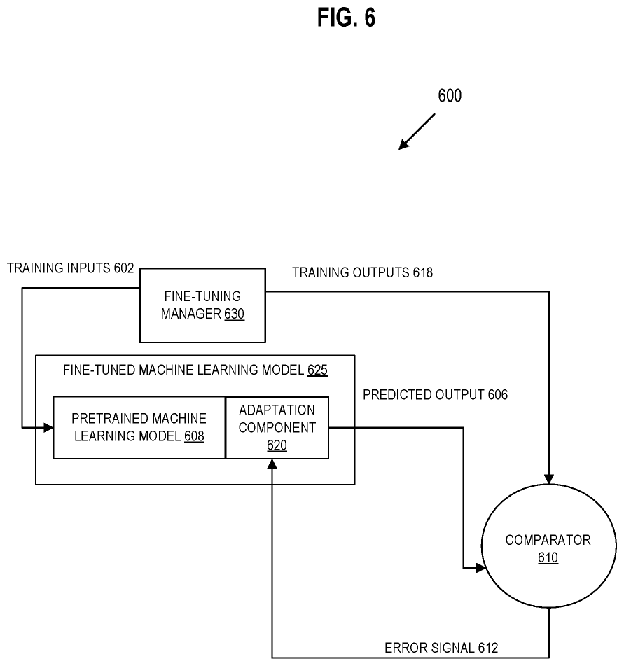

The LLM 156 is a generalized pretrained machine learning model that has been pretrained to perform general tasks using-domain neutral data. In some embodiments, the LLM 156 is a generative pretrained transformer (GPT) machine learning model. In some embodiments, the storage system 140 includes a pretrained machine learning model 120. The pretrained machine learning model 120 may be a machine learning model that has been pretrained using domain-neutral data. In some embodiments, the pretrained machine learning model 120 is more efficient than the LLM 156 (e.g., a smaller machine leaning model architecture). As described with reference to FIG. 6 below, the pretrained machine learning model 120 is fine-tuned to obtain the fine-tuned model 110. In some embodiments, the fine-tuned model 110 is a multi-headed machine learning model. A multi-headed machine learning model is a single machine learning model that is trained to perform multiple tasks. That is, during fine-tuning of the pretrained machine learning model 120 via the fine-tuning manager 162 described herein, the pretrained machine learning model 120 iteratively develops statistical correlations that enable the fine-tuned model 110 to identify complex patterns encoded in domain-specific data (in addition to, or instead of, the complex patterns encoded in the domain-neutral data) associated with multiple tasks. For example, the fine-tuned model 110 is trained to perform a first task (e.g., classification), a second task (e.g., entity extraction), a third task (e.g., question and answer), and a fourth task (e.g., text summarization).

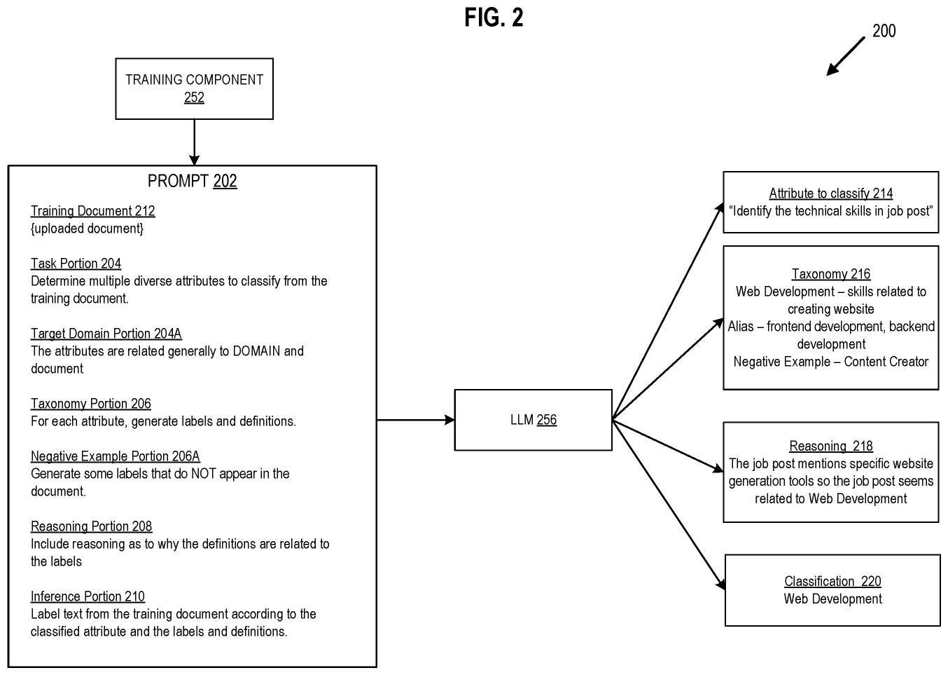

As shown in the example of FIG. 1, in operation, the training component 152 obtains content items 106 by querying the storage system 140, and receiving, from the storage system 140, content items 106. The training component 152 uses the content items 106 as training documents for the LLM 156. Each stored content item in content items 160 is an unlabeled digital content item. In some embodiments, the content items 160 can be documents uploaded by a user (e.g., resume, job post, blog, article, etc.) without any additional metadata or processing. The training component 152 passes prompt 154 to the LLM 156 which instructs the LLM 156 to generate training data (e.g., input-output pairs 132) associated with the content item 160. As described with reference to FIGS. 2-5, the training component 152 uses prompts 154 to instruct the LLM 156 to generate an input of an input-output pair 132 and a corresponding output of the input-output pair associated with one or more tasks for each content item. In operation, the LLM 156 generates task-specific input-output pairs (e.g., classification-specific input-output pairs, entity extraction-specific input-output pairs, question-and-answer-specific input-output pairs, and summarization-specific input-output pairs). For example, the prompt 154 instructs the LLM 156 to generate a first set of input-output pairs 132 for the first task (e.g., a classification task), a second set of input-output pairs 132 for the second task (e.g., an extraction task), a third set of input-output pairs 132 for the third task (e.g., a summarization task), and a fourth set of input-output pairs 132 for the fourth task (e.g., a question-answer task).

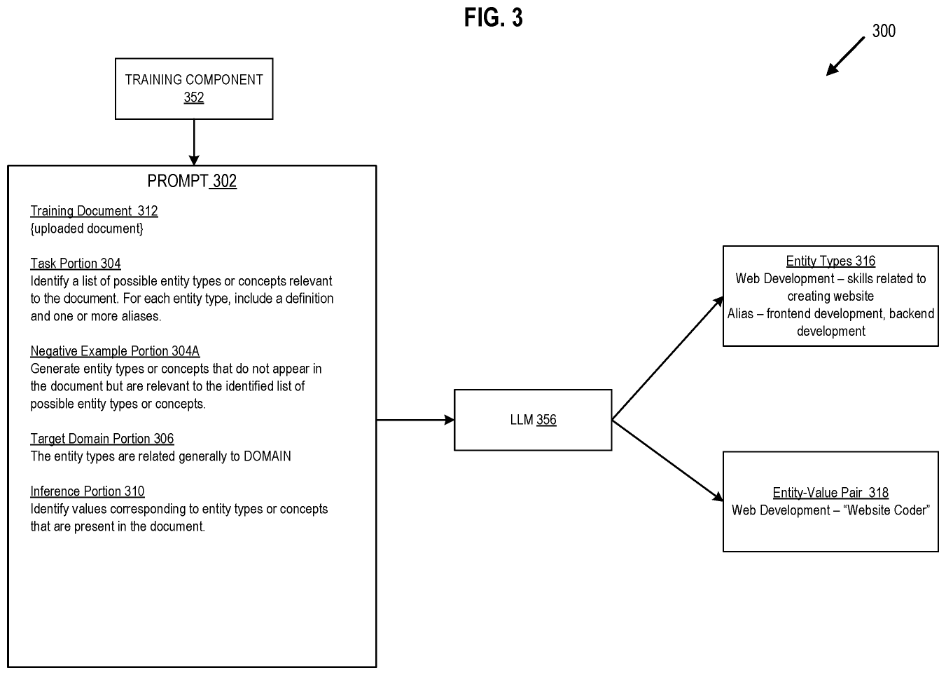

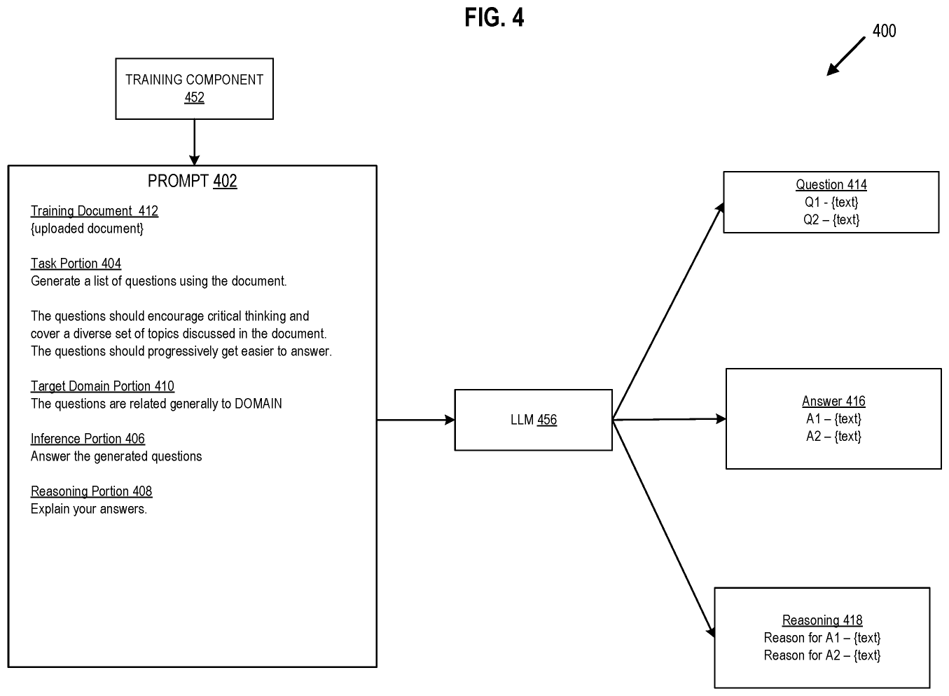

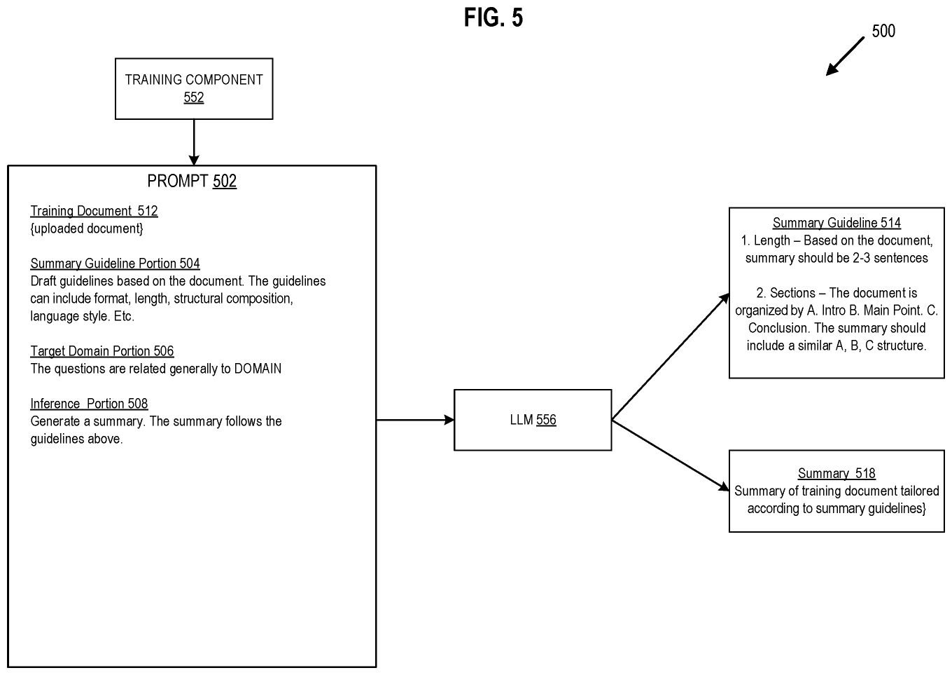

In some embodiments, each task to be learned by the pretrained machine learning model 120 is associated with a specific prompt 154. That is, each task-specific input-output pair is associated with a specific prompt 154. FIG. 2 describes the prompts used for the for classification-specific input-output pairs, FIG. 3 describes the prompts used for the for extraction-specific input-output pairs, FIG. 4 describes the prompts used for the for question and answer-specific input-output pairs, and FIG. 5 describes the prompts used for the for summarization-specific input-output pairs. In other words, there is a one-to-one mapping between the instructions used to generate each set of task-specific training data. This one-to-one mapping between the instruction (e.g., prompt 154) and each task stems from the different challenges associated with obtaining information from LLM 156. For example, the prompt 154 used to generate classification-specific input-output pairs associated with the classification task instructs the LLM 156 to generate a taxonomy and also instructs the LLM 156 to describe or otherwise define each of the labels included in the generated taxonomy based on a particular content item 160 and the LLM 156 knowledge of the labels of the taxonomy. In contrast, the prompt 154 used to generate question and answer-specific input-output pairs associated with the question-and-answer task instructs the LLM 156 to generate a list of questions based on the behavior of users asking questions and the particular content item 160.

Training data associated with a domain-specific task is generated in a scalable manner using a single task-specific prompt. For example, the training component 152 uses a first prompt 154-1 (not shown) associated with a first task (e.g., a classification task) to generate the first task-specific input-output pairs, a second prompt 154-2 (not shown) associated with a second task (e.g., an entity extraction task) to generate the second task-specific input-output pairs, a third prompt 154-3 (not shown) associated with a third task (e.g., a question and answer task) to generate the third task-specific input-output pairs, and a fourth prompt 154-4 (not shown) associated with a fourth task (e.g., a summarization task) to generate the fourth task-specific input-output pairs. In operation, a single task-specific prompt 154 can be applied to a diverse set of content items 160 to generate a diverse set of task-specific training data. This is because the task-specific prompt 154 instructs the LLM 156 to perform a specific task that is broadly associated with the obtained content item 108, thereby rooting the generated input-output pairs 132 to the obtained content item 108 instead of a particular task instruction.

In some embodiments, before content items 160 are used to generate input-output pairs 132, user permission is obtained. For example, an author of a content item 160 consents to using content item 160 as training data.

As described herein, manually generating input-output pairs 104 is costly, time-consuming, and error prone. Accordingly, the number of manual input-output pairs 104 used by the fine-tuning manager 162 to fine-tune the pretrained machine learning model 120 is limited. The LLM 156 expands or otherwise supplements the limited set of training data (e.g., manual input-output pairs 104) used for fine-tuning the pretrained machine learning model 120 by generating both an input and a corresponding output of an input-output pair 132 (e.g., part of training data 136). The generated training data 114 is passed to the storage system 140 for storage as training data 136.

The fine-tuning manager 158 obtains training data 170 by querying the storage system 140 for input-output pairs 132, and receiving, from the storage system 140, the training data 136 including input-output pairs 132. The fine-tuning manager 158 also obtains prompts 164 by querying the storage system 140 for the task-specific prompt templates 112 and receiving, from the storage system 140, the task-specific prompt templates 112. Each task-specific prompt template 112 is a prompt associated with a task to be performed. For example, there is a first prompt 164-1 (not shown) of the task-specific prompt templates 112 associated with training the pretrained machine learning model 120 to perform a first task (e.g., a classification task), and a second prompt 164-2 (not shown) of the task-specific prompt templates 112 associated with training the pretrained machine learning model 120 to perform a second task (e.g., an extraction task). Each prompt 164 used to train the pretrained machine learning model 120 includes one or more portions of the prompt used by the fine-tuned model 110 during inference (e.g., when the fine-tuned model 110 is performing a task at a time other than during the fine-tuning performed by the fine-tuning manager 158). That is, the first prompt 164-1 (not shown) includes portions of the prompt received by the fine-tuned machine learning model when performing the first task during inference. Similarly, the second prompt 164-2 (not shown) associated with the second task includes portions of the prompt received by the fine-tuned model 110 when performing the second task during inference. Fine-tuning the pretrained machine learning model 120 using prompts 164 and the fine-tuning manager 158 is described with reference to FIG. 6.

In some embodiments, the pretrained machine learning model 120 is an LLM. As a result of fine-tuning the pretrained machine learning model 120 using the training data 136 (e.g., input-output pairs 132), the pretrained machine learning model 120 becomes the fine-tuned model 110. The fine-tuning manager 158 stores the fine-tuned model 172 in the storage system 140 as fine-tuned model 110. In some embodiments, the training component 152 performs the operations of the fine-tuning manager 158.

In some embodiments, the fine-tuning manager 158 can further fine-tuned the fine-tuned model 110. For example, the obtained training data 170 received from the storage system 140 can include manual input-output pairs 104 used to further fine-tuned the fine-tuned model. The further fine-tuned model can be stored in the storage system 140.

In some embodiments, the fine-tuned model 110 can be used to generate training data 136. Specifically, given an input (e.g., an input of the input-output pair 132) or an instruction to perform a task, the fine-tuned model 110 can generate an output (e.g., and output of the input-output pair 132) corresponding to the input. In some embodiments, the generated training data 136 is stored as input-output pairs 132. In some embodiments, a user can verify the training data 124, as described above.

The examples shown in FIG. 1 and the accompanying description above are provided for illustration purposes. This disclosure is not limited to the described examples. Additional or alternative details and implementations are described herein.

FIG. 2 is an example flow diagram for generating training data for a classification task, in accordance with some embodiments of the present disclosure.

As described herein, a prompt instructs a LLM of one or more tasks to be performed by the LLM. Example 200 illustrates a portion of prompt 202 passed to LLM 256 by the training component 252 to create task 1 training data (e.g., a set of input-output pairs 132 described in FIG. 1) based on downstream task 1, where downstream task 1 is a classification task, for instance. As described herein, there is a one-to-one mapping between the instructions used to generate data for the classification task (using prompt 202, for instance) and the downstream classification task. The classification task includes assigning labels from a given taxonomy to a document based on the content in the document. A taxonomy is a list of labels which may be associated with a definition and/or one or more aliases. An alias is a synonym or other semantically similar word or phrase associated with the label. While example 200 illustrates seven portions of prompt 202 (e.g., training document 212, task portion 204, target domain portion 204A, taxonomy portion 206, negative example portion 206A, reasoning portion 208, and inference portion 210), other portions of a prompt can be included in prompt 202 and passed to LLM 256. As described herein, the training data generated by the LLM 256 responsive to prompt 202 are based on the training document (e.g., the content of the training document). Accordingly, prompt 202 can be used to generate a diverse set of training data used to train a machine learning model to perform a downstream classification task given a diverse set of training documents. That is, the same or similar portions of prompt 202 provided to LLM 256 over a diverse a set of training documents can cause the LLM 256 to generate a diverse set of training data associated with the set of training documents.

The training document 212 includes a reference to a document (such as a URL, a document identifier, etc.) and/or content of the document to be used by the LLM 256 as a training document. The document is a domain-specific digital content item (e.g., content items 160 described in FIG. 1). For example, given the domain of an online system for jobs or job candidates over a professional social network that includes information about companies, job postings, and users of the online system, the document can include a job post, a resume, a blog, a user profile, a comment, an article, or an email.

The task portion 204 is a broad instruction associated with a target task. As shown, task portion 204 is associated with a classification task and instructs the LLM 256 to identify one or more attributes to be classified using the training document of the training document 212. For example, attributes mentioned in a training document if the training document is a resume, can include “technical skills,” “education,” “work history,” or “hobbies.” The attributes identified by the LLM 256 are dependent on the content of the training document. For example, some resumes include a “hobby” portion. Additionally, the attributes identified by the LLM 256 are dependent on the training document. For example, attributes mentioned in a training document if the training document is a job post can include “work culture,” “industry experience,” and “technical skills” for instance. However, such attributes may not be present in a training document if the training document is an article, for instance.

As shown, responsive to the task portion 204 instructing the LLM 256 to identify an attribute from the training document (identified via training document 212), the LLM 256 outputs one or more attributes to classify 214. For example, given a job post training document, an attribute identified in the job post is “technical skills.” Accordingly, the LLM 256 determines the “technical skills” attribute is an attribute to be classified from the job post.

The target domain portion 204A instructs the LLM 256 to adjust the way the LLM 256 performs the tasks included in the prompt 202. For example, the target domain portion 204A describes a target domain such as an online system for jobs or job candidates over a professional social network. As a result of the target domain specification included in the target domain portion 204A, the LLM 256 biases information specific to the target domain. That is, instead of performing the tasks identified in the prompt 202 according to any general knowledge learned during pretraining of the LLM 256, the LLM 256 performs the tasks in the prompt 202 according to the target domain specified by the target domain portion 204A. In this manner, the attribute to classify 214, the taxonomy 216, the reasoning 218, and the classification 220 are biased towards the target domain.

In some embodiments, the instructions in the target domain portion 204A are dependent on the content of the training document (e.g., identified in the training document 212). For example, if the training document is a resume (e.g., a first type of training document), then there is a first target domain instruction in the target domain portion 204A. Alternatively, if the training document is a user profile (e.g., a second type of training document), then there is a second target domain instruction in the target domain portion 204A.

The taxonomy portion 206 instructs the LLM 256 to generate one or more labels associated with the attribute identified using the task portion 204. For example, labels associated with a “certification type” attribute associated with a job post in the trucking industry can include “driver's license,” or “class B license” for instance. In some embodiments, the taxonomy portion 206 further instructs the LLM 256 to generate definitions associated with each label. In some embodiments, the taxonomy portion 206 further instructs the LLM 256 to generate aliases associated with each label. Responsive to the instructions in the taxonomy portion 206, the LLM generates taxonomy 216. As shown, the taxonomy 216 includes one or more labels associated with the attribute and based on the training document. For example, given the “technical skills” attribute identified from a job post training document, the taxonomy 216 includes technical skills (e.g., labels) identified in the job post training document, such as web development. The LLM 256 defines the label web development (e.g., skills related to creating a website, described in taxonomy 216) and also includes aliases associated with the web development label (e.g., frontend development, backend development, described in taxonomy 216).

The negative example portion 206A instructs the LLM 256 to generate negative training examples, which are labels that are absent from the training document (e.g., null labels). A negative training example, or a null label, is a label that is associated with the content of the training document yet absent from the training document. In some embodiments, the negative training examples are included as part of the taxonomy 216.

The negative training examples can be “hard” negative examples or “soft” negative examples. A hard negative example is an example with a similarity value that satisfies a threshold similarity value with respect to a label determined using the taxonomy portion 206. A soft negative example is an example with a similarity value that does not satisfy a threshold similarity value with respect to the label determined using the taxonomy portion 206 (e.g., a taxonomy label identified in taxonomy 216).

A similarity value is determined using an embedding representation of the negative training example and an embedding representation of the label determined using the taxonomy portion 206. An embedding is a latent space representation that encodes the meaning of the negative training example and taxonomy label in an embedding space. Embeddings of training examples and taxonomy labels that are associated with similar meanings are positioned closer together in embedding space.

To determine the similarity value with respect to the negative training example and a taxonomy label, the embedding of the negative training example is compared to the embedding of the taxonomy label. In some embodiments, cosine similarity is applied to the pairs of compared embeddings to quantify the similarity between the embeddings. In operation, the value of the cosine of the angle between the compared embeddings in embedding space indicates a similarity of embeddings. For example, higher, positive values (closer to 1) indicate greater degrees of similarity and lower, negative values (closer to 0) indicate greater degrees of dissimilarity.

If the compared embedding of the negative training example and the embedding of the taxonomy label produce a similarity value that does not satisfy a threshold similarity value, then the negative training example is a soft negative example. If the compared embedding of the negative training example and the embedding of the taxonomy label produce a similarity value that does satisfy the threshold similarity value, then the negative training example is determined to be semantically similar to the taxonomy label and is therefore a hard negative example. Because the negative training example is semantically similar to the taxonomy label, it is statistically likely that the negative training example can be mis-identified as a taxonomy label. As described above, taxonomy labels are associated with the attribute and based on the training document, while negative examples (including the hard negative example) are labels that are absent from the document. For example, the taxonomy 216 includes a label “web development” and a negative example “content creator.” While “content creator” is semantically similar to the label “web development,” the training document (e.g., a job post), does not describe content creation.

The inclusion of negative training examples is used to minimize LLM hallucination by presenting the LLM with information that the LLM cannot solve (e.g., labels that are absent from the training document). For example, during training of the pretrained machine learning model described in FIG. 6, the pretrained model discerns relevant labels identified from a document from labels that are not applicable given the content of the document. In operation, the pretrained machine learning model iteratively develops statistical correlations that associate the negative examples with null values, reducing the likelihood that the pretrained machine learning model will generate values (e.g., hallucinate content) associated with the negative examples.

The reasoning portion 208 instructs the LLM 256 to provide reasoning as to why the definitions, generated in the taxonomy 216, are related to the labels, generated in the taxonomy 216. Responsive to the instructions in the reasoning portion 208. The LLM 256 generates reasoning 218. Reasoning 218 is one example of transferring or otherwise distilling domain-specific information from LLM 256. For example, as described above, LLM 256 can be a pretrained language model trained on general knowledge. Instructing the LLM 256 to explain how definitions are related to labels implicitly forces the LLM 256 to provide domain-specific contextualization associated with the labels, where the labels which are based on attributes identified from the domain-specific training documents.

The inference portion 210 instructs the LLM 256 to perform a downstream task using the training document (provided via the training document 212) and the taxonomy (e.g., taxonomy 216 determined via taxonomy portion 206 and negative example portion 206A). The downstream task is the attribute to be classified (e.g., attribute to classify 214 determined via task portion 204). Responsive to the inference portion 210, the LLM 256 identifies the labels in the training document as classification 220. Even though the taxonomy 216 may include negative examples (determined via the negative example portion 206A), the classification 220 would not include a negative training example because the negative training examples are not included in, or relevant to, the training document. The classification 220 is an example of a training output corresponding to a training input (e.g., the attribute to classify 214, the taxonomy 216, and the training document 212). In some embodiments, the reasoning 218 and the classification 220 are the output corresponding to the training input.

FIG. 3 is an example flow diagram for generating training data for an extraction task, in accordance with some embodiments of the present disclosure.

As described herein, a prompt instructs a LLM of one or more tasks to be performed by the LLM. Example 300 illustrates a portion of prompt 302 passed to LLM 356 by the training component 352 to create task 2 training data (e.g., a set of input-output pairs 132 described in FIG. 1) based on downstream task 2, where downstream task 2 is an extraction task, for instance. As described herein, there is a one-to-one mapping between the instructions used to generate data for the extraction task (using prompt 302, for instance) and the downstream extraction task. The extraction task includes identifying and extracting specific entities from an input document. While example 300 illustrates five portions of prompt 302 (e.g., training document 312, task portion 304, negative example portion 304A, target domain portion 306, and inference portion 310) other portions of a prompt can be included in prompt 302 and passed to LLM 356. As described herein, the tasks performed by the LLM 356 responsive to prompt 302 are based on the training document (e.g., the content of the training document). Accordingly, prompt 302 can be used to generate a diverse set of training data used to train a machine learning model to perform a downstream extraction task given a diverse set of training documents. That is, the same or similar portions of prompt 302 provided to LLM 356 over a diverse a set of training documents can cause the LLM 356 to generate a diverse set of training data associated with the set of training documents.

The training document 312 is similar to the training document 212 described in FIG. 2. For example, the training document 312 includes a reference to a document and/or content of the document to be used by the LLM 356 as a training document.

The task portion 304 is a broad instruction associated with a target task. As shown, task portion 304 is associated with an entity extraction task and instructs the LLM 356 to identify a list of possible entity types or concepts relevant to the training document identified in the training document 312. In some embodiments, the entities identified from the training document can include words or phrases extracted directly from the training document. Accordingly, the entities extracted by the LLM 356 are dependent on the content of the training document. In some embodiments, the task portion 304 instructs the LLM to generate definitions associated with each extracted entity. In some embodiments, the task portion 304 further instructs the LLM 356 to generate aliases associated with each extracted entity.

As shown, responsive to the task portion 304 instruction, the LLM 356 identifies entity types 316, or a list of entities that are associated with the content of the training document 312. In some embodiments, the LLM 356 defines each of the entities that are associated with the content of the training document 312 and/or provides aliases for each of the entities associated with the content of the training document 312 as part of the entity types 316.

The negative example portion 304A instructs the LLM 356 to generate negative training examples, which are entities that are absent from the training document. In some embodiments, the negative training examples are included as part of the entity types 316 generated responsive to the task portion 304. Similar to the negative training examples generated via the negative example portion 206A described in FIG. 2, the negative training examples generated via negative example portion 304A can be hard negative examples or soft negative examples. Hard negative examples are negative training samples that are semantically similar to entities extracted from the document. That is, the comparison of an embedding of a negative training sample and an embedding of an extracted entity produces a similarity value that satisfies a threshold similarity value. Soft negative examples are negative training samples that are not as similar to entities extracted from the document (e.g., the hard negative training examples are more similar to entities extracted from the document than the soft negative examples). That is, the comparison of an embedding of a negative training sample and an embedding of an extracted entity produces a similarity value that does not satisfy a threshold similarity value. The inclusion of the negative example portion 304A enables the pretrained model to determine, during fine-tuning described in FIG. 6, the difference between absent and present entities in a received document. In operation, the pretrained machine learning model iteratively develops statistical correlations that associate the negative examples with null values, reducing the likelihood that the pretrained machine learning model will generate values (e.g., hallucinate content) associated with the negative examples.

The target domain portion 306 instructs the LLM 356 to adjust the way the LLM 356 performs the tasks included in the prompt 302. For example, the target domain portion 306 describes a target domain such as an online system for jobs or job candidates over a professional social network. Accordingly, the target domain portion 306 guides the LLM 356 to extract entities (e.g., entity types 316) and values (e.g., entity-value pairs 318) that are relevant to the target domain of an online system for jobs or job candidates over a professional social network. That is, instead of performing the tasks identified in the prompt 302 according to any general knowledge learned during pretraining of the LLM 356, the LLM 356 performs the tasks in the prompt 302 according to the target domain specified by the target domain portion 306. In this manner, the entity types 316 and entity-value pairs 318 are biased towards the target domain.

The inference portion 310 instructs the LLM 356 to perform a downstream task using the training document (provided via the training document 312) and the entity types (e.g., the entity types 316 determined via the task portion 304 and negative example portion 304A). The downstream task is identifying a value of the training document corresponding to the extracted entity type. The values are string matches of one or more words from the training document. In the case of negative examples included in the entity types 316, the corresponding value is “null” or “none.” Accordingly, responsive to the inference portion 310, the LLM 356 provides pairs of entities and corresponding pairs extracted from the training document as entity-value pair 318. The entity-value pair 318 is an example of a training output corresponding to a training input (e.g., the entity types 316 and the training document 312).

FIG. 4 is an example flow diagram for generating training data for a question-and-answer task, in accordance with some embodiments of the present disclosure.

As described herein, a prompt instructs a LLM of one or more tasks to be performed by the LLM. Example 400 illustrates a portion of prompt 402 passed to LLM 456 by the training component 452 to create task 3 training data (e.g., a set of input-output pairs 132 described in FIG. 1) based on downstream task 3, where downstream task 3 is a question-and-answer task, for instance. As described herein, there is a one-to-one mapping between the instructions used to generate data for the question-and-answer task (using prompt 402, for instance) and the downstream question and answer task. The question-and-answer task includes answering a question using domain-specific knowledge. While example 400 illustrates five portions of prompt 402 (e.g., training document 412, task portion 404, target domain portion 410, inference portion 406 and reasoning portion 408), other portions of a prompt can be included in prompt 402 and passed to LLM 456. As described herein, the tasks performed by the LLM 456 responsive to prompt 402 are based on the training document (e.g., the content of the training document). Accordingly, prompt 402 can be used to generate a diverse set of training data used to train a machine learning model to perform a downstream question and answer task given a diverse set of training documents. That is, the same or similar portions of prompt 402 provided to LLM 456 over a diverse a set of training documents can cause the LLM 456 to generate a diverse set of training data associated with the set of training documents.

The training document 412 is similar to the training document 212 described in FIG. 2. For example, the training document 412 includes a reference to a document and/or content of the document to be used by the LLM 456 as a training document.

The task portion 404 is a broad instruction associated with a target task. As shown, task portion 404 is associated with a question-and-answer task and instructs the LLM 456 to generate a list of questions using the document provided via the training document 412. The task portion 404 can include some additional instructions about the generated questions. For example, the task portion 404 instructs the LLM 465 to generate questions that should encourage critical thinking and cover a diverse set of topics in the document. The additional instructions can instruct the LLM 456 to generate subsequent questions in a list of questions being easier to answer. In some embodiments, the additional instructions regarding the generated questions consider the question patterns associated with the question-and-answer task. For example, in some embodiments, users asking a question to an LLM generally begin with a more difficult and more specific question first, and progressively ask easier questions. Such question patterns associated with users and the downstream task can be included in the task portion 404. As described above, there is a one-to-one mapping between the instructions used to generate the question-and-answer data (e.g., questions 414) and the downstream question and answer task. Responsive to the question behavior and instructions in the task portion 404, the LLM 456 generates questions 414. The questions 414 can be about the content of the document, subject matter related to the content of the document, subject matter inferred from the content of the document, or the like. The format of the questions is based on the additional information included in the task portion 404. For example, question 1 of question 414 is more difficult (e.g., more abstract, less related to the training document 412) than question 2 of question 414.

The target domain portion 410 instructs the LLM 456 to adjust the way the LLM 456 performs the tasks included in the prompt 402. For example, the target domain portion 410 describes a target domain such as an online system for jobs or job candidates over a professional social network. Accordingly, the target domain portion 410 guides the LLM 356 to generate questions 414 and answers 416 that are relevant to the target domain of an online system for jobs or job candidates over a professional social network. That is, instead of performing the tasks identified in the prompt 402 according to any general knowledge learned during pretraining of the LLM 456, the LLM 456 performs the tasks in the prompt 402 according to the target domain specified by the target domain portion 410. In this manner, the questions 414 and answers 416 are biased towards the target domain.

The inference portion 406 instructs the LLM 456 to perform a downstream task using the training document (provided via the training document 412) and the questions 414. The downstream task is answering each question in the list of questions 414. That is, responsive to the questions 414, the LLM 456 generates answers 416. The answers 416 can mirror the same style (e.g., vocabulary, formality, tone) as the style of the uploaded document (e.g., vocabulary, formality, tone).

The reasoning portion 408 instructs the LLM 456 to provide reasoning as to the generated answers 416. Responsive to the instructions in the reasoning portion 408, the LLM 456 generates reasoning 418. Reasoning 418 is one example of transferring or otherwise distilling domain-specific information from LLM 456. For example, as described above, LLM 456 can be a pretrained language model trained on general knowledge. Instructing the LLM 456 to explain how and why the LLM 456 generated answers 416 are responsive to questions 414 in light of the document forces the LLM 456 to provide domain-specific contextualization associated with the answers 416. In this manner, the reasoning 418 includes domain-specific information. The exposure to a diverse range of documents (via training document 412) and the reasoning portion 408 instructing the LLM 456 to critically think prepares downstream models for a variety of analytical domain-specific tasks.

The answers 416 are an example of a training output corresponding to a training input (e.g., questions 414 and training document 412). In some embodiments, the reasoning 418 is included as part of the training output corresponding to the training input.

FIG. 5 is an example flow diagram for generating training data for a summarization task, in accordance with some embodiments of the present disclosure.

As described herein, a prompt instructs a LLM of one or more tasks to be performed by the LLM. Example 500 illustrates a portion of prompt 502 passed to LLM 556 by the training component 552 to create task 4 training data (e.g., a set of input-output pairs 132 described in FIG. 1) based on downstream task 4, where downstream task 4 is a summarization task, for instance. As described herein, there is a one-to-one mapping between the instructions used to generate data for the summarization task (using prompt 502, for instance) and the downstream summarization task. The text summarization task is more than generating concise version of text. As shown below, the summarization task includes generating a summary of text according to a set of requirements such as summary length, summary format, summary style, and summary content focus. While example 500 illustrates four portions of prompt 502 (e.g., training document 512, summary guidelines portion 504, inference portion 508, and target domain portion 510) other portions of a prompt can be included in prompt 502 and passed to LLM 556. As described herein, the tasks performed by the LLM 556 responsive to prompt 502 are based on the training document (e.g., the content of the training document). Accordingly, prompt 502 can be used to generate a diverse set of training data used to train a machine learning model to perform a downstream text summarization task given a diverse set of training documents. That is, the same or similar portions of prompt 502 provided to LLM 356 over a diverse a set of training documents can cause the LLM 556 to generate a diverse set of training data associated with the set of training documents.

The training document 512 is similar to the training document 212 described in FIG. 2. For example, the training document 512 includes a reference to a document and/or content of the document to be used by the LLM 556 as a training document.

The summary guideline portion 504 instructs the LLM 556 to generate a list of instructions tailored to the training document. The summary guidelines portion 504 can include summary instructions with respect to summary length, summary format, summary style (e.g., language style), summary structural composition, and summary content focus (e.g., specific guidelines on what to include and what to avoid). Responsive to the summary guideline portion 504 instructing the LLM 556 to generate a set of guidelines for the summary, the LLM 556 generates summary guidelines 514 that constrain or otherwise guide the summary in terms of summary length, summary format, summary style, and summary content focus, for instance. In a non-limiting example, based on the document length being half a page, the summary guidelines 514 suggest that the summary should be 2-3 sentences. In another non-limiting example, based on the document being divided into Section A, Section B, and Section C, the summary guidelines 514 suggest that the summary should similarly have a Section A, Section B, and Section C structure.

The target domain portion 506 instructs the LLM 556 to adjust the way the LLM 556 performs the tasks included in the prompt 502. For example, the target domain portion 506 describes a target domain such as an online system for jobs or job candidates over a professional social network. Accordingly, the target domain portion 506 guides the LLM 556 to summarize text (e.g., summary 518) that is relevant to the target domain of an online system for jobs or job candidates over a professional social network. That is, instead of performing the tasks identified in the prompt 502 according to any general knowledge learned during pretraining of the LLM 556, the LLM 556 performs the tasks in the prompt 502 according to the target domain specified by the target domain portion 506. In this manner, the summary guidelines 514 and summary 518 are biased towards the target domain.

The inference portion 508 instructs the LLM 556 to perform a downstream task using the training document (provided via the training document 512) and the summary guidelines (e.g., the summary guidelines 514 determined via the summary guideline portion 504). The downstream task is summarizing the content of the training document using the summary guidelines 514 as summary 518. Accordingly, the summary 518 is a summary of text of the training document according to a set of summary guidelines 514 requirements such as summary length, summary format, summary style, and summary content focus.

FIG. 6 is an example method for fine-tuning a large language model, in accordance with some embodiments of the present disclosure.

The pretrained machine learning model 608 can be any sequence-to-sequence machine learning model. For example, the pretrained machine learning model 608 can include an instance of a text-based encoder-decoder model that accepts a string as an input and outputs a string. The pretrained machine learning model 608 is trained on domain-neutral data (e.g., publicly available data) to perform one or more domain-neutral tasks. The pretrained machine learning model 608 can be pretrained using any training method such as supervised learning, unsupervised learning, semi-supervised learning, reinforcement learning, etc.

A layer may refer to a sub-structure of the pretrained machine learning model 608 that includes a number of nodes (e.g., neurons) that perform a particular computation and are interconnected to nodes of adjacent layers. Nodes in each of the layers sum up values from adjacent nodes and apply an activation function, allowing the layers to detect nonlinear patterns. Nodes are interconnected by weights, which are adjusted based on an error during a training phase. The adjustment of the weights during training enables the pretrained machine learning model 608 to perform the domain-neutral tasks (e.g., text extraction, text summarization, classification) with a certain degree of confidence or reliability. At the completion of training, the pretrained machine learning model 608 includes a set of pretrained weights in a pretrained weight matrix trained to perform one or more domain-neutral tasks using domain-neutral data.

The pretrained machine learning model 608 includes one or more self-attention layers that are used to attend (e.g., assign weight values) to portions of the model input. Alternatively, or in addition, the pretrained machine learning model 608 includes one or more feed-forward layers and residual connections that allow the pretrained machine learning model 608 to encode or decode complex data patterns including relationships between different portions of the model input in multiple different contexts.

Fine-tuning the pretrained machine learning model 608 allows the pretrained machine learning model 608, which has a general natural language understanding, to perform domain-specific tasks. The fine-tuning manager 630 fine-tunes an adaptation component 620 using domain-specific data causing the fine-tuned machine learning model 625 to iteratively develop statistical correlations that enable the fine-tuned machine learning model 624 to perform one or more domain-specific tasks. The adaptation component 620 can include one or more weight matrices appended to one or more weight matrices in the pretrained machine learning model 608 and one or more layers appended to one or more layers of the pretrained machine learning model 608. The fine-tuned (or trained) adaptation component 620 together with the pretrained machine learning model 608 results in the fine-tuned machine learning model 625. Fine-tuning the pretrained machine learning model 608 is fine-tuning (or training) the adaptation component 620 without changing the domain-neutral pretrained weights of the pretrained weight matrix.

As described herein, supervised learning is a method of training a machine learning model given input-output pairs. The input-output pair is training data used to train the adaptation component 620 to perform a domain-specific task. While one adaptation component 620 is shown, it should be appreciated that multiple adaptation components 620 can be appended to layers and/or weights of the pretrained machine learning model 608.

In some embodiments, a first adaptation component 620 is trained (or fine-tuned) to perform a first downstream task such as a classification task using classification-specific input-output pairs. The input of the classification-specific input-output pair, represented as training inputs 602, includes the training document (e.g., domain-specific training content), the attributes to classify (e.g., attributes to classify 214 described in FIG. 2), and a taxonomy (e.g., the generated taxonomy 216 described in FIG. 2). In some embodiments, the fine-tuning manager 630 masks out one or more definitions and/or aliases of the taxonomy. The output of the classification-specific input-output pair, represented as training output 618, is used to train the adaptation component 620 to perform the classification task. The training output 618 can be a classification of text of the training document (e.g., classification 220 described in FIG. 2). In some embodiments, the training output 618 also includes reasoning (e.g., reasoning 218 described in FIG. 2).

As a result of training the first adaptation component 620 using the training data (e.g., the classification-specific input-output pairs), the adaptation component 620 iteratively develops statistical correlations that enable the fine-tuned machine learning model 625 to perform domain-specific classification tasks. In operation, the fine-tuned machine learning model 625 develops statistical correlations associated with a diverse set of domain-specific vocabulary (e.g., defined according to the taxonomy), which increases the encoded domain-specific vocabulary and enables the fine-tuned machine learning model 625 to perform robust classification of text in documents.

In some embodiments, the first adaptation component 620 can be further fine-tuned using additional classification-specific input-output pairs. In some embodiments, the training input 602 and the training output 618 of the additional classification-specific input-output pairs are manually determined attributes to classify, taxonomies, corresponding classifications, and reasoning (e.g., manual input-output pairs 104 described in FIG. 1). That is, an LLM (such as LLM 256 described in FIG. 2) may not generate the training inputs 602 and training outputs 618.

In some embodiments, a second adaptation component 620 is trained (or fine-tuned) to perform a second downstream task such as entity extraction using entity extraction-specific input-output pairs. The input of the entity extraction-specific input-output pairs, represented as training inputs 602, includes the training document (e.g., domain-specific training content) and a list of possible entity types (e.g., entity types 316 described in FIG. 3). The output of the entity extraction-specific input-output pairs, represented as training output 618, is used to train the adaptation component 620 to perform the extraction task. The training output 618 can be values included in the training document that are related to entities in the list of possible entities (e.g., entity-value pair 318 described in FIG. 3).

As a result of training the second adaptation component 620 using the training data (e.g., the entity extraction-specific input-output pairs), the adaptation component 620 iteratively develops statistical correlations that enable the fine-tuned machine learning model 625 to perform domain-specific entity extraction tasks. In operation, the entity extraction-specific input-output pairs enable the fine-tuned machine learning model 625 to perform robust entity extraction capabilities. Unlike conventional named entity recognition (NER) tagging, the fine-tuned machine learning model 625 can extract arbitrary domain-specific entities from a training document. The diverse range of entity types received as part of the training input 602 increases the domain-specific vocabulary encoded by the adaptation component 620. As a result, the fine-tuned machine learning model 625 develops statistical correlations associated with a diverse set of domain-specific entities and corresponding values obtained from a diverse set of training documents.

In some embodiments, the second adaptation component 620 can be further tine-tuned using additional entity extraction-specific input-output pairs. In these embodiments, the training input 602 and the training output 618 of the additional entity extraction-specific input-output pairs are manually determined entity types and entity-value pairs (e.g., manual input-output pairs 104 described in FIG. 1). That is, an LLM (such as LLM 356 described in FIG. 3) may not generate the training inputs 602 and training outputs 618.

In some embodiments, a third adaptation component 620 is trained (or fine-tuned) to perform a third downstream task such as a question-and-answer task using question and answer-specific input-output pairs. The input of the question and answer-specific input-output pairs, represented as training inputs 602, includes the training document (e.g., domain-specific training content) and questions (e.g., questions 414 described in FIG. 4). The output of the question and answer-specific input-output pairs, represented as training output 618, is used to train the adaptation component 620 to perform the question-and-answer task. The training output 618 can be answers to questions about the training document (e.g., answers 416 described in FIG. 4). In some embodiments, the training output 618 also includes reasoning for the answers (e.g., reasoning 418 described in FIG. 4).

As a result of training the third adaptation component 620 using the training data (e.g., the question and answer-specific input-output pairs), the adaptation component 620 iteratively develops statistical correlations that enable the fine-tuned machine learning model 625 to perform domain-specific question-and-answer tasks. In operation, the question and answer-specific input-output pairs enable the fine-tuned machine learning model 625 to iteratively develop statistical correlations that support critical reasoning in a domain-specific context. The fine-tuned machine learning model 625 generates content (e.g., answers) associated with deep analytical reasoning.

In some embodiments, the third adaptation component 620 can be further fine-tuned using additional question and answer-specific input-output pairs. In these embodiments, the training input 602 and the training output 618 of the additional question and answer-specific input-output pairs are manually determined questions and answers (e.g., manual input-output pairs 104 described in FIG. 1). That is, an LLM (such as LLM 456 described in FIG. 4) may not generate the training inputs 602 and training outputs 618.

In some embodiments, a fourth adaptation component 620 is trained (or fine-tuned) to perform a fourth downstream task such as text summarization using summarization-specific input-output pairs. The input of the summarization-specific input-output pairs, represented as training inputs 602, include the training document (e.g., domain-specific training content) and summary guidelines (e.g., summary guidelines in 514 described in FIG. 5). The output of the summarization-specific input-output pairs, represented as training output 618, is used to train the adaptation component 620 to perform the text summarization task. The training output can be a text summary of the training document (e.g., summary 518 described in FIG. 5).

As a result of training the fourth adaptation component 620 using the training data (e.g., the summarization-specific input-output pairs), the adaptation component 620 iteratively develops statistical correlations that enable the fine-tuned machine learning model 625 to perform domain-specific text summarization tasks. In operation, the summarization-specific input-output pairs enable the fine-tuned machine learning model 625 to follow diverse summarization instructions (e.g., summary guidelines 514 described in FIG. 5) that improve the fine-tuned machine learning model 625 ability to produce tailored summaries for a diverse set of documents.

In some embodiments, the fourth adaptation component 620 can be further fine-tuned using additional summarization-specific input-output pairs. In these embodiments, the training input 602 and the training output 618 of the summarization-specific input-output pairs are manually determined summary guidelines and text summaries (e.g., manual input-output pairs 104 described in FIG. 1). That is, an LLM (such as LLM 556 described in FIG. 5) may not generate the training inputs 602 and training outputs 618.

In some embodiments, the fine-tuned machine learning model 625 is a multi-headed machine learning model. A multi-headed machine learning model is a single machine learning model that is trained to perform multiple tasks. Each head of the multi-headed machine learning model includes a stack of layers (e.g., adaptation component 620) that performs a task associated with that head. Accordingly, a first head of the fine-tuned machine learning model 625 includes the first adaptation component 620 trained to perform the classification task, a second head of the fine-tuned machine learning model 625 includes the second adaptation component 620 trained to perform the entity extraction task, a third head of the fine-tuned machine learning model 625 includes the third adaptation component 620 trained to perform the question-and-answer task, and a fourth head of the fine-tuned machine learning model 625 includes the fourth adaptation component 620 trained to perform the text summarization task. In some embodiments, each head utilizes a loss function to train the particular head to perform a task.

The fine-tuning manager 630 fine-tunes one or more adaptation components 620 using the task-specific input-output pairs described above (e.g., classification-specific input-output pairs, entity extraction-specific input-output pairs, question and answer-specific input-output pairs, and summarization-specific input-output pairs). In some embodiments, the adaptation component 620 is initialized with the weights of the pretrained machine learning model 608. In some embodiments, the adaptation component 620 is initialized with a low-rank pair of matrices that represent the interconnections between non-redundant neurons in the pretrained machine learning model (e.g., Low-Rank Adaptation of weights). In some embodiments, the adaptation component 620 is initialized with random weight values.

Supervised learning is a method of training (or fine-tuning) the weight values of a machine learning model (e.g., the pretrained machine learning model 608 or the adaptation component 620) given input-output pairs. In some embodiments, the fine-tuning manager 630 fine-tunes the weights in the pretrained machine learning model 608. For example, the value of the pretrained weights in the pretrained weight matrix is adjusted according to an error (e.g., the error 612 determined by the comparator 610 comparing the training output 618 to the predicted output 606). In other embodiments, the pretrained weight matrix of the pretrained machine learning model 608 is frozen and the weights of the adaptation component 620 are trained. While supervised learning is described, other training methods including semi-supervised learning or federated learning can be used to fine-tune the pretrained machine learning model 608 and/or adaptation component 620.

In the example 600, the fine-tuning manager 630 provides a prompt including the training inputs 602 (e.g., an input of the task-specific input-output pairs described above) to the pretrained machine learning model 608. In some embodiments, the prompt is dependent on the task to be trained. For example, the fine-tuning manager 630 provides a first prompt associated with a first task (e.g., the classification task), the fine-tuning manager 630 provides a second prompt associated with a second task (e.g., the entity extraction task), the fine-tuning manager 630 provides a third prompt associated with the third task (e.g., the question and answer task), and the fine-tuning manager 630 provides a fourth prompt associated with a fourth task (e.g., the text summarization task).

In some embodiments, the prompt associated with each task is a prompt template that is based on the downstream task. For example, the first prompt associated with the first task mimics the prompt received by the fine-tuned machine learning model 625 when performing that first task during inference (e.g., during deployment of the fine-tuned machine leaning model 625 at a time other than during training). That is, the first prompt includes portions of the prompt received by the fine-tuned machine learning model when performing the first task during inference. Similarly, the second prompt associated with the second task mimics the prompt received by the fine-tuned machine learning model 625 when performing the second task during inference. In some embodiments, the prompt template associated with each task is unique. In other embodiments, the prompt template associated with each task is the same (or portions of the prompt are the same or similar).

The fine-tuning manager 630 can train (or fine-tune) the adaptation component 620 and/or pretrained machine learning model 608 using the prompt templates because of the targeted task-specific input-output pairs generated using a pretrained LLM. That is, the burden of transferring domain-specific information to the fine-tuned machine learning model 742 (e.g., distilling information) and prompt engineering is shifted from an administrator generating prompts for training the pretrained machine learning model 608 and/or the adaptation component 620 to the LLM used to generate training data (e.g., LLM 256 described in FIG. 2, LLM 356 described in FIG. 3, LLM 456 described in FIG. 4, and LLM 556 described in FIG. 5). As described herein, the task specific-inputs and outputs are generated by an LLM such that the domain-specific knowledge associated with the LLM performing the task is transferred to a more efficient (e.g., fewer weights, neurons, layers) machine learning model such as fine-tuned machine learning model 625. In other words, if the fine-tuning manager 630 did not have access to the task-specific input-output pairs generated by the LLM (e.g., LLM 256 described in FIG. 2, LLM 356 described in FIG. 3, LLM 456 described in FIG. 4, and LLM 556 described in FIG. 5), then a prompt template that includes portions of the prompt received by the fine-tuned machine learning model 625 during inference may not be an effective prompt to fine-tune the pretrained machine learning model 608 and/or adaptation component 620. For example, the prompt template can include a few lines of a task-specific instruction. In a non-limiting example, a first prompt template associated with an extraction task can instruct the pretrained machine learning model 608 and/or the fine-tuned machine learning model 625 to “extract { } entities from the following document. The output format should be JSON.” Such a broad prompt may not be effective at fine-tuning the pretrained machine learning model 608 to perform the extraction task if not for the specific training inputs 602 and training outputs 618 used during supervised learning. That is, the specific training inputs 602, the training outputs 618, and the broad prompt templates enable the fine-tuned machine learning model 625 to develop statistical correlations used to perform the domain-specific downstream task with a threshold degree of certainty.

A task-specific input of the task-specific input-output pairs (e.g., represented generally as training input 602) is provided to the pretrained machine learning model 608 via a task-specific prompt template by the fine-tuning manager 630. The pretrained machine learning model and the adaptation component 620 then determine predicted output 606 by applying the weights and nodes of the pretrained machine learning model 608 and the weights and/or nodes of the adaptation component 620 to the training input.

The predicted output 606 is the task specific predicted output associated with the task specific input. The error (represented by the error signal 612) is determined by comparing the predicted output 606 to the training output 618 using the comparator 610. In operation, given a training input 602 of the classification-specific input-output pairs (e.g., training document, attributes to classify, and a taxonomy), the predicted output 606 is a classification, which is compared to the training output 618 classification (e.g., classification 220 described in FIG. 2). In some embodiments, the predicted output 606 and the training output 618 include reasoning for the classification. Given a training input 602 of the entity extraction-specific input-output pairs (e.g., training document and a list of possible entity types), the predicted output 606 is one or more values included in the training document that are related to entities in the list of possible entities (e.g., entity-value pairs) and the training output 618 includes entity-value pairs (e.g., entity-value pairs 318 described in FIG. 3). Given a training input 602 of the question and answer-specific input-output pairs (e.g., a question), the predicted output 606 is an answer and the training output 618 is an answer (e.g., answer 416 described in FIG. 4). In some embodiments, the predicted output 606 and training output 618 include reasoning for the answer. Given a training input 602 of the summarization-specific input-output pairs (e.g., training document and summary guidelines), the predicted output 606 is a summary of the training document in accordance with the summary guidelines and the training output 618 is a summary of the training document in accordance with the summary guidelines (e.g., summary 518 described in FIG. 5).

In some embodiments, the comparator 610 evaluates the similarity between the predicted output 606 to the training output 618 using any similarity metric. For example, the comparator 610 can compare the similarity of the text strings of a predicted output 606 to the text strings of the training output 618 using the Recall-Oriented Understudy for Gisting Evaluation (ROUGE) score.

The error signal 612 is used to adjust the adaptation component 620 (e.g., the value of weights in a weight matrix included in the adaptation component 620 and/or the number of layers and/or arrangement of layers included in the adaptation component 620). The adjustment of the adaptation component 620 during training enables the fine-tuned machine learning model 625 to iteratively develop statistical correlations used to perform the domain-specific task associated with the input-output pair.

The adaptation component 620 and/or pretrained machine learning model 608 may be trained using a backpropagation algorithm, for instance. The backpropagation algorithm operates by propagating the error signal 612 through each of the algorithmic weights of the adaptation component 620 and/or pretrained machine learning model 608 such that the algorithmic weights adapt based on the amount of error. The error signal 612 may be calculated at each iteration (e.g., each input-output pair), batch, and/or epoch. After a set of training iterations, the fine-tuned machine learning model 625 iteratively converges, e.g., changes over time to generate an acceptably accurate (e.g., accuracy satisfies a defined tolerance or confidence level) predicted output 606 using the training input 602 and the training output 618. The value of the weights is stored such that the fine-tuned machine learning model 625 can be deployed during inference time.

FIG. 7 is a block diagram of a computing system that includes a training manager, in accordance with some embodiments of the present disclosure.

In the embodiment of FIG. 7, a computing system 700 includes one or more user systems 710, a network 716, an application software system 730, a training manager 750, and a data storage system 740. All or at least some components of the training manager 750 and/or fine-tuned machine learning model 742 are implemented at the user system 710, in some implementations. For example, the training manager 750 and/or fine-tuned machine learning model 742 can be implemented directly upon a single client device and/or the application software system 730 without the need to communicate with, e.g., one or more servers over the Internet.

A user system 710 includes at least one computing device, such as a personal computing device, a server, a mobile computing device, or a smart appliance, and at least one software application that the at least one computing device is capable of executing, such as an operating system or a front end of an online system. A typical user of user system 710 can be an administrator (such as a user creating input-output pairs for fine-tuning the fine-tuned machine learning model 742 or otherwise responsible for training the fine-tuned machine learning model 742).

Many different user systems 710 can be connected to network 716 at the same time or at different times. Different user systems 710 can contain similar components as described in connection with the illustrated user system 710. For example, many different end users of computing system 700 can be interacting with many different instances of application software system 730 through their respective user systems 710, at the same time or at different times.

User system 710 includes a user interface 712. User interface 712 is installed on or accessible to user system 710 by network 716. The user interface 712 can include, for example, a graphical display screen that includes graphical user interface elements such as at least one input box or other input mechanism and at least one slot. A slot as used herein refers to a space on a graphical display such as a web page or mobile device screen, into which natural language text can be entered by a user and/or user selections are received. The locations and dimensions of a particular graphical user interface element on a screen are specified using, for example, a markup language such as HTML (Hypertext Markup Language). On a typical display screen, a graphical user interface element is defined by two-dimensional coordinates. In other implementations such as virtual reality or augmented reality implementations, a slot may be defined using a three-dimensional coordinate system.

In some implementations, user interface 712 enables the user to upload, download, receive, send, or share of other types of digital content items, including posts, articles, comments, and shares, to initiate user interface events, and to view or otherwise perceive output such as data and/or digital content produced by application software system 730 and/or content distribution service 738. For example, user interface 712 can include a graphical user interface (GUI), a conversational voice/speech interface, a virtual reality, augmented reality, or mixed reality interface, and/or a haptic interface. User interface 712 includes a mechanism for logging in to application software system 730, clicking or tapping on GUI user input control elements, and interacting with digital content. Examples of user interface 712 include web browsers, command line interfaces, and mobile app front ends. User interface 712 as used herein can include application programming interfaces (APIs).

In the example of FIG. 7, user interface 712 includes a front-end user interface component of application software system 730. For example, user interface 712 can be directly integrated with other components of any user interface of application software system 730. In some implementations, access to content of the application software system 730 is limited to registered users of application software system 730.

Network 716 includes an electronic communications network. Network 716 can be implemented on any medium or mechanism that provides for the exchange of digital data, signals, and/or instructions between the various components of computing system 700. Examples of network 716 include, without limitation, a Local Area Network (LAN), a Wide Arca Network (WAN), an Ethernet network or the Internet, or at least one terrestrial, satellite or wireless link, or a combination of any number of different networks and/or communication links.

Application software system 730 includes any type of application software system that provides or enables the creation, upload, display, and/or distribution of at least one form of digital content, including user profiles, articles, comments, and videos between or among user systems, such as user system 710, through user interface 712. In some implementations, portions of the training manager 750 are components of application software system 730. Components of application software system 730 can include user connection network 736, content distribution service 738, and fine-tuned machine learning model 742.

User connection network 736 includes, for instance, a social network service, professional social network software and/or other social graph-based applications. Application software system 730 can include, for example, online systems that provide social network services, general-purpose search engines, specific-purpose search engines, messaging systems, content distribution platforms, e-commerce software, enterprise software, or any combination of any of the foregoing or other types of software.

A front-end portion of application software system 730 can operate in user system 710, for example as a plugin or widget in a graphical user interface of a web application, mobile software application, or as a web browser executing user interface 712. In an embodiment, a mobile app or a web browser of a user system 710 can transmit a network communication such as an HTTP (HyperText Transfer Protocol) request over network 716 in response to user input that is received through a user interface provided by the web application, mobile app, or web browser, such as user interface 712. A request is formulated, e.g., by a browser or mobile app at a user device, in connection with a user interface event such as uploading or storing a digital content item. The request includes, for example, a network message such as an HTTP request to store a digital content (e.g., a transfer of data from an application front end to the application's back end, or from the application's back end to the front end, or, more generally, a request for a transfer of data between two different devices or systems, such as data transfers between servers and user systems). A server running application software system 730 can receive the input from the web application, mobile app, or browser executing user interface 712, perform at least one operation using the input, and return output to the user interface 712 using a network communication such as an HTTP response, which the web application, mobile app, or browser receives and processes at the user system 710.

In the example of FIG. 7, application software system 730 includes a content distribution service 738. The content distribution service 738 can include a data storage service, such as a web server, which stores digital content items, uploaded by users, created by users, and/or searched for by users. Content distribution service 738 includes, for example, a chatbot or chat-style system, a messaging system, such as a peer-to-peer messaging system that enables the creation and exchange of messages among users of application software system 730, or a news feed. Such generated content can be stored in storage system 740 as content items of the content item data store 720. In some implementations, content distribution service 738 interfaces with application software system 730, for example, via one or more application programming interfaces (APIs).

In the example of FIG. 7, the training manager 750 includes a training component 752 and fine-tuning manager 754 to train machine learning models to perform domain-specific tasks. The training performed by the training manager 750 is performed in a training pipeline that first generates domain-specific training data (e.g., task-specific input-output pairs) and second uses the generated domain-specific training data to fine-tune a domain-neutral pretrained machine learning model.

The training component 752 performs a first stage of the training pipeline. The training component 752 is used to generate an input of an input-output pair and an output corresponding to the input of the input-output pair using a generalized pretrained machine learning model (such as LLM 156 described in FIG. 1). FIGS. 2-5 describe how the training component 752 uses a specific prompt to generate task-specific input-output pairs. The training data generated by the LLM is stored in the training data store 722.

The fine-tuning manager 754 performs a second stage of the training pipeline. The fine-tuning manager 754 fine-tunes a pretrained machine learning model to become a fine-tuned machine learning model 742 by fine-tuning (or training) an adaptation component. The adaptation component, together with the pretrained machine learning model, results in the fine-tuned machine learning model 742. In some embodiments, the fine-tuned machine leaning model 742 is any machine learning model such as an LLM. In some embodiments, the fine-tuned machine learning model 742 has an architecture with fewer weights, nodes, or layers than the architecture of the LLM used to generate training data (such as LLM 156 described in FIG. 1).

The pretrained machine learning model can be any machine learning model pretrained to perform on or more tasks using domain-neutral data. The fine-tuning manager 754 can be used to fine-tune the adaptation component to perform various domain-specific tasks. For example, using task-specific input-output pairs generated using the training component 752 (e.g., classification-specific input-output pairs, entity extraction-specific input-output pairs, question and answer-specific input-output pairs, and summarization-specific input-output pairs), the pretrained machine learning model can be fine-tuned to the fine-tuned machine learning model 742, which can perform a classification task, an extraction task, a question-and-answer task, and a summarization task respectively.

Data storage system 740 includes data stores and/or data services that store digital data received, used, manipulated, and produced by application software system 730 and/or training manager 750, including a content item data store 720, and training data store 722, and a task-specific prompt template data store 724.

The content item data store 720 stores digital content items hosted by the application software system 730, generated by the application software system 730, uploaded to the application software system 730, and the like. In some embodiments, digital content is tagged with privacy settings such that only users with one or more credentials have access to the tagged digital content. Content items stored in content item data store 720 can include job postings, comments, resumes, and articles. In some embodiments, content items include unstructured data. Unstructured data includes files stored without metadata or a predetermined format such as free-form text (e.g., one or more words, phrases, or sentences). In some embodiments, content items include structured data. Structured data is data in a predetermined format (e.g., JSON format, bullet points).

The training data store 722 stores pairs of training data (e.g., input-output pairs). As described herein, an input-output pair includes an input generated by a generalized pretrained machine learning model (such as LLM 156 described in FIG. 1), and document used to generate the input. The output of the input-output pair corresponds to the input and can include reasoning. The training data store 722 can include sets of input-output pairs, where each set is associated with a task. For example, a first set of input-output pairs include classification-specific input-output pairs associated with a classification task, a second set of input-output pairs include entity extraction-specific input-output pairs associated with an entity-extraction task, a third set of input-output pairs include question and answer-specific input-output pairs associated with a question and answer task, and a fourth set of input-output pairs include summarization-specific input-output pairs associated with a summarization task. In some embodiments, the input-output pairs stored in the training data store 722 are manually determined (e.g., entered via a user using user interface 712). The training data store 722 can be queried to obtain task-specific input-output pairs used by the fine-tuning manager 754 to train the fine-tuned machine learning model 742.

The task-specific prompt template data store 724 stores task-specific prompts used to generate task specific training data. As described herein, task-specific input-output pairs stored in the training data store 722 can be associated with a task-specific prompt. FIG. 2 describes the prompts used for the classification-specific input-output pairs, FIG. 3 describes the prompts used for the entity extraction-specific input-output pairs, FIG. 4 describes the prompts used for the question and answer-specific input-output pairs, and FIG. 5 describes the prompts used for the summarization-specific input-output pairs.

The task-specific prompt template data store 724 also stores task-specific prompts used during fine-tuning the fine-tuned machine learning model 742. As described herein, the prompts used during fine-tuning the fine-tuned machine learning model 742 can include one or more similar portions to the prompts used during deployment of the fine-tuned machine learning model 742. For example, a task-specific prompt template can include a few lines of a task-specific instruction. As described herein, the task specific-inputs and outputs are generated by an LLM using the training component 752 such that the domain-specific knowledge associated with the LLM performing the task is transferred to a more efficient (e.g., fewer weights, neurons, layers) machine learning model such as the fine-tuned machine learning model 742. In other words, if the fine-tuning manager 754 did not have access to the task-specific input-output pairs generated by the LLM using the training component 752, then the task-specific prompt template that includes portions of the prompt received by the fine-tuned machine learning model 742 during inference may not be an effective prompt to fine-tune the pretrained machine learning model. In general, the task-specific prompt templates may not be effective at fine-tuning the pretrained machine learning model to perform a specific task if not for the task-specific training input-output pairs generated using the training component 752.

In some embodiments, the data storage system 740 includes multiple different types of data storage and/or a distributed data service. As used herein, data service may refer to a physical, geographic grouping of machines, a logical grouping of machines, or a single machine. For example, a data service may be a data center, a cluster, a group of clusters, or a machine. Data stores of the data storage system 740 can be configured to store data produced in real-time and/or offline (e.g., batch) data processing. Data stored in real time is data that is stored as soon as the data is received by the data storage system 740. A data store configured for real-time data processing can be referred to as a real-time data store. A data store configured for offline or batch data processing can be referred to as an offline data store. Data stores can be implemented using databases, such as key: value stores, relational databases, and/or graph databases. Data can be written to and read from data stores using query technologies, e.g., SQL or NoSQL.

A key: value database, or key: value store, is a nonrelational database that organizes and stores data records as key: value pairs. The key uniquely identifies the data record, i.e., the value associated with the key. The value associated with a given key can be, e.g., a single data value, a list of data values, or another key: value pair. For example, the value associated with a key can be either the data being identified by the key or a pointer to that data. A relational database defines a data structure as a table or group of tables in which data are stored in rows and columns, where each column of the table corresponds to a data field. Relational databases use keys to create relationships between data stored in different tables, and the keys can be used to join data stored in different tables. Graph databases organize data using a graph data structure that includes a number of interconnected graph primitives. Examples of graph primitives include nodes, edges, and predicates, where a node stores data, an edge creates a relationship between two nodes, and a predicate is assigned to an edge. The predicate defines or describes the type of relationship that exists between the nodes connected by the edge.

The data storage system 740 resides on at least one persistent and/or volatile storage device that can reside within the same local network as at least one other device of computing system 700 and/or in a network that is remote relative to at least one other device of computing system 700. Thus, although depicted as being included in computing system 700, portions of data storage system 740 can be part of computing system 700 or accessed by computing system 700 over a network, such as network 716.

While not specifically shown, it should be understood that any of user system 710, application software system 730, training manager 750, and data storage system 740 includes an interface embodied as computer programming code stored in computer memory that when executed causes a computing device to enable bidirectional communication with any other of user system 710, application software system 730, training manager 750, or data storage system 740 using a communicative coupling mechanism. Examples of communicative coupling mechanisms include network interfaces, inter-process communication (IPC) interfaces and application program interfaces (APIs).

Each of user system 710, application software system 730, training manager 750, and data storage system 740 is implemented using at least one computing device that is communicatively coupled to electronic communications network 716. Any of user system 710, application software system 730, training manager 750, and data storage system 740 can be bidirectionally communicatively coupled by network 716. User system 710 as well as other different user systems (not shown) can be bidirectionally communicatively coupled to application software system 730 and/or training manager 750.

Terms such as component, system, and model as used herein refer to computer implemented structures, e.g., combinations of software and hardware such as computer programming logic, data, and/or data structures implemented in electrical circuitry, stored in memory, and/or executed by one or more hardware processors.

The features and functionality of user system 710, application software system 730, training manager 750, and data storage system 740 are implemented using computer software, hardware, or software and hardware, and can include combinations of automated functionality, data structures, and digital data, which are represented schematically in the figures. User system 710, application software system 730, training manager 750, and data storage system 740 are shown as separate elements in FIG. 7 for case of discussion but, except as otherwise described, the illustration is not meant to imply that separation of these elements is required. The illustrated systems, services, and data stores (or their functionality) of each of user system 710, application software system 730, training manager 750, and data storage system 740 can be divided over any number of physical systems, including a single physical computer system, and can communicate with each other in any appropriate manner.

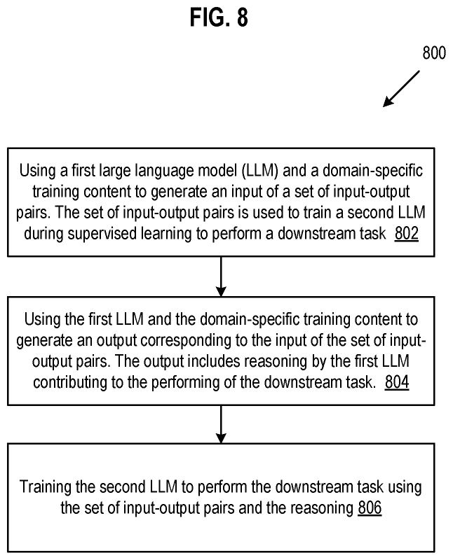

FIG. 8 is a flow diagram of an example method for training a large language model using generated training data, in accordance with some embodiments of the present disclosure.

The method 800 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, one or more portions of method 800 is performed by one or more components of the training manager 750 of FIG. 7, or the training manager 150 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

At operation 802, a processing device generates an input of a set of input-output pairs using a first large language model (LLM) and a domain-specific training content. The set of input-output pairs is used to train a second LLM during supervised learning to perform a downstream task. At operation 804, the processing device generates an output corresponding to the input of the set of input-output pairs using the first LLM and the domain-specific training content. The output includes reasoning by the first LLM contributing to the performing of the downstream task.

As described herein, a two-stage training pipeline is used to train a machine learning model (e.g., the second LLM) to perform a domain-specific task. In the first stage of the training pipeline, a training component uses the first LLM to generate an input of an input-output pair and an output of the input-output pair.

In some implementations, the set of input-output pairs is a first set of input-output pairs and the downstream task is a classification task. The LLM generates the first set of input-output pairs using a first prompt. In these implementations, the first prompt includes an instruction to classify an attribute based on the domain-specific training document. For example, the first prompt includes a task portion 204 described in FIG. 2. The first prompt can also include an instruction to generate a taxonomy based on the attribute. For example, the first prompt can include a taxonomy portion 206 described in FIG. 2. The first prompt can also include an instruction to identify a label of the domain-specific training document associated with the attribute and based on the taxonomy. For example, the first prompt can include an inference portion 210 described in FIG. 2. The first prompt can also include an instruction to provide a reasoning for the identified label. For example, the first prompt can include a reasoning portion 208 described in FIG. 2. The reasoning for the identified label is the reasoning by the first LLM contributing to performing the classification task, such as reasoning 218 described in FIG. 2. The first prompt can also include an instruction to identify a null label associated with the domain specific training content. For example, the first prompt can include a negative example portion 206A described in FIG. 2. The null label is associated with the attribute determined by the first LLM. In these implementations, the input of the classification-specific input-output pair can include the training document, the attribute to classify 214 responsive to the task portion 204, and the taxonomy 216 responsive to the taxonomy portion 206 described in FIG. 2. In some implementations, the taxonomy 216 includes negative examples responsive to the negative example portion 206A described in FIG. 2. The output of the classification-specific input-output pair can include the reasoning 218 responsive to the reasoning portion 208 and the classification 220 responsive to the inference portion 210 described in FIG. 2.

In some implementations, the set of input-output pairs is a second set of input-output pairs and the downstream task is an entity extraction task. The LLM generates the second set of input-output pairs and the downstream task is an entity extraction task. The LLM generates the second set of input-output pairs using a second prompt. In these implementations, the second prompt includes an instruction to identify a set of entities based on the domain-specific training content. For example, the second prompt can include a task portion 304 described in FIG. 3. The second prompt can also include an instruction to identify a set of values corresponding to the set of entities. For example, the second prompt can include an inference portion 310 described in FIG. 3. The second prompt can also include an instruction to identify a null entity associated with the domain-specific training content. For example, the second prompt can include a negative example portion 304A described in FIG. 3. The null entity is associated with the set of entities determined by the first LLM. In these implementations, the input of extraction-specific input-output pair can include the training document and the entity type 316 responsive to the task portion 304 described in FIG. 3. In some implementations, the entity type 316 described in FIG. 3 includes negative examples responsive to the negative example portion 304A. The output of the extraction-specific input-output pair can include the entity-value pair 318 responsive to the inference portion 310 described in FIG. 3.

In some implementations, the set of input-output pairs is a third set of input-output pairs and the downstream task is a question-and-answer task. The LLM generates the third set of input-output pairs using a third prompt. In these implementations, the third prompt includes an instruction to generate a list of questions based on the domain-specific training content. For example, the third prompt can include a task portion 404 described in FIG. 4. The third prompt can also include an instruction to generate answers corresponding to questions of the list of questions. For example, the third prompt can include an inference portion 406 described in FIG. 4. The third prompt can also include an instruction to provide reasoning for each answer. For example, the third prompt can include a reasoning portion 408 described in FIG. 4. In these implementations, the input of the question-and-answer specific input-output pair can include questions 414 responsive to the task portion 404 described in FIG. 4. The output of the question-and-answer specific input-output pair can include the answers 416 responsive to the inference portion 406 described in FIG. 4. In some implementations, the output of the question-and-answer specific input-output pair can include reasoning 418 responsive to the reasoning portion 408 described in FIG. 4.

In some implementations, the set of input-output pairs is a fourth set of input-output pairs and the downstream task is a summarization. The LLM generates the fourth set of input-output pairs using a fourth prompt. In these implementations, the fourth prompt includes an instruction to generate a set of guidelines based on the domain specific training content. For example, the third prompt can include summary guidelines portion 504 described in FIG. 5. The third prompt can also include an instruction to generate a summary of the domain-specific training content, where the summary uses the set of guidelines. For example, the third prompt can include an inference portion 508 described in FIG. 5. In these implementations, the input of the summarization specific input-output pair can include summary guidelines 514 responsive to the summary guideline portion 504 described in FIG. 5. The output of the summarization specific input-output pair can include the summary 518 responsive to the inference portion 508 described in FIG. 5.

At operation 806, the processing device trains the second LLM to perform the downstream task using the set of input-output pairs and the reasoning. For example, if the downstream task is a classification task, then the second LLM can be trained to identify the label of the domain-specific training content associated with the attribute and based on the taxonomy. The second LLM can be trained using the domain-specific training content, the attribute based on the domain-specific training content, and the taxonomy. In some implementations, the second LLM is trained to provide reasoning for the identified label. If the downstream task is an entity extraction task, then the second LLM can be trained to identify the set of values corresponding to the set of entities based on the domain-specific training content. The second LLM can be trained using the domain-specific training content and the set of entities. If the downstream task is a question-and-answer task, then the second LLM can be trained to generate answers corresponding to questions of a list of questions. In some implementations, the second LLM is trained to provide reasoning for the generated answers. The second LLM can be trained using the domain-specific training content and the list of questions based on the domain-specific training content. If the downstream task is a summarization task, then the second LLM can be trained to generate a summary using the domain-specific training content and the set of guidelines.

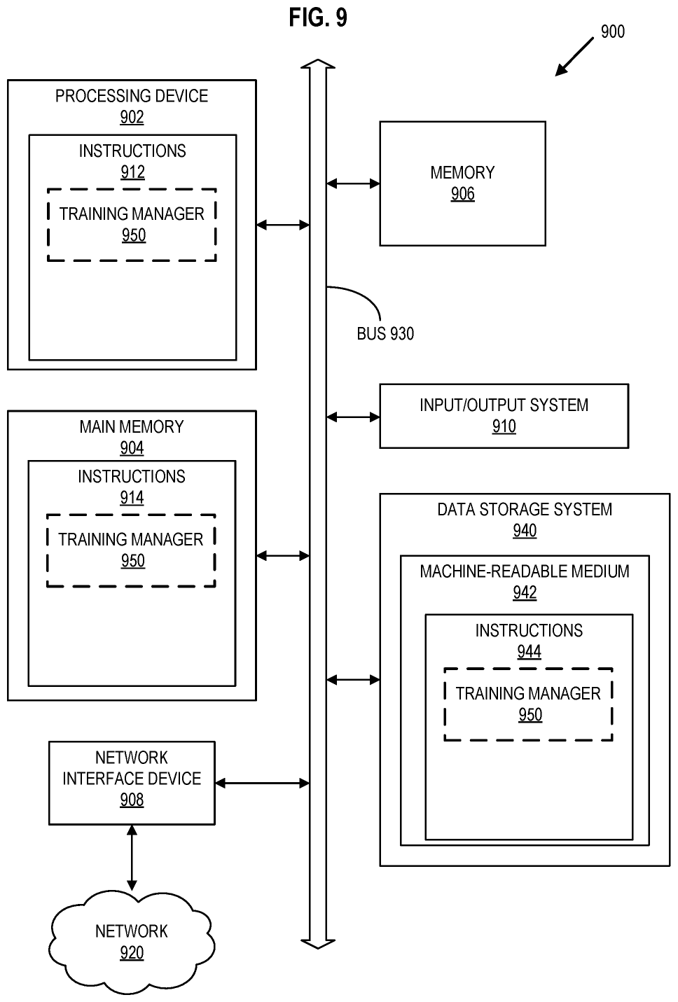

FIG. 9 is a block diagram of an example computer system including a training manager, in accordance with some embodiments of the present disclosure.

In FIG. 9, an example machine of a computer system 900 is shown, within which a set of instructions for causing the machine to perform any of the methodologies discussed herein can be executed. In some embodiments, the computer system 900 can correspond to a component of a networked computer system (e.g., as a component of the training manager 150 of FIG. 1 or the training manager 750 of FIG. 7) that includes, is coupled to, or utilizes a machine to execute an operating system to perform operations corresponding to one or more components of the training manager 150 of FIG. 1 or the training manager 750 of FIG. 7. For example, computer system 900 corresponds to a portion of computing system 100 when the computing system is executing a portion of the training manager 150 of FIG. 1.

The machine is connected (e.g., networked) to other machines in a network, such as a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine is a personal computer (PC), a smart phone, a tablet PC, a set-top box (STB), a Personal Digital Assistant (PDA), a cellular telephone, a web appliance, a wearable device, a server, or any machine capable of executing a set of instructions (sequential or otherwise) that specify actions to be taken by that machine. Further, while a single machine is illustrated, the term “machine” includes any collection of machines that individually or jointly execute a set (or multiple sets) of instructions to perform any of the methodologies discussed herein.

The example computer system 900 includes a processing device 902, a main memory 904 (e.g., read-only memory (ROM), flash memory, dynamic random access memory (DRAM) such as synchronous DRAM (SDRAM) or Rambus DRAM (RDRAM), etc.), a memory 903 (e.g., flash memory, static random access memory (SRAM), etc.), an input/output system 910, and a data storage system 940, which communicate with each other via a bus 930.

Processing device 902 represents at least one general-purpose processing device such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 902 can also be at least one special-purpose processing device such as an application specific integrated circuit (ASIC), a field programmable gate array (FPGA), a digital signal processor (DSP), network processor, or the like. The processing device 902 is configured to execute instructions 912 for performing the operations and steps discussed herein.

In some embodiments of FIG. 9, training manager 950 represents portions of training manager 750 of FIG. 7 when the computer system 900 is executing those portions of training manager 950. Instructions 912 include portions of the training manager 950 when those portions of the training manager 950 are being executed by processing device 902. Thus, the training manager 950 is shown in dashed lines as part of instructions 912 to illustrate that, at times, portions of the training manager 950 are executed by processing device 902. For example, when at least some portion of the training manager 950 is embodied in instructions to cause processing device 902 to perform the method(s) described herein, some of those instructions can be read into processing device 902 (e.g., into an internal cache or other memory) from main memory 904 and/or data storage system 940. However, it is not required that all of the training manager 950 be included in instructions 912 at the same time and portions of the training manager 950 are stored in at least one other component of computer system 900 at other times, e.g., when at least one portion of the training manager 950 is not being executed by processing device 902.

The computer system 900 further includes a network interface device 908 to communicate over the network 920. Network interface device 908 provides a two-way data communication coupling to a network. For example, network interface device 908 can be an integrated-services digital network (ISDN) card, cable modem, satellite modem, or a modem to provide a data communication connection to a corresponding type of telephone line. As another example, network interface device 908 can be a local area network (LAN) card to provide a data communication connection to a compatible LAN. Wireless links can also be implemented. In any such implementation network interface device 908 can send and receive electrical, electromagnetic, or optical signals that carry digital data streams representing various types of information.

The network link can provide data communication through at least one network to other data devices. For example, a network link can provide a connection to the world-wide packet data communication network commonly referred to as the “Internet,” for example through a local network to a host computer or to data equipment operated by an Internet Service Provider (ISP). Local networks and the Internet use electrical, electromagnetic, or optical signals that carry digital data to and from computer system computer system 900.

Computer system 900 can send messages and receive data, including program code, through the network(s) and network interface device 908. In the Internet example, a server can transmit a requested code for an application program through the Internet and network interface device 908. The received code can be executed by processing device 902 as it is received, and/or stored in data storage system 940, or other non-volatile storage for later execution.

The input/output system 910 includes an output device, such as a display, for example a liquid crystal display (LCD) or a touchscreen display, for displaying information to a computer user, or a speaker, a haptic device, or another form of output device. The input/output system 910 can include an input device, for example, alphanumeric keys and other keys configured for communicating information and command selections to processing device 902. An input device can, alternatively or in addition, include a cursor control, such as a mouse, a trackball, or cursor direction keys for communicating direction information and command selections to processing device 902 and for controlling cursor movement on a display. An input device can, alternatively or in addition, include a microphone, a sensor, or an array of sensors, for communicating sensed information to processing device 902. Sensed information can include voice commands, audio signals, geographic location information, haptic information, and/or digital imagery, for example.

The data storage system 940 includes a machine-readable storage medium 942 (also known as a computer-readable medium) on which is stored at least one set of instructions 944 or software embodying any of the methodologies or functions described herein. The instructions 944 can also reside, completely or at least partially, within the main memory 904 and/or within the processing device 902 during execution thereof by the computer system 900, the main memory 904 and the processing device 902 also constituting machine-readable storage media. In one embodiment, the instructions 944 include instructions to implement functionality corresponding to the application software system 730 of FIG. 7 (e.g., training manager 150 of FIG. 1 or the training manager 950 of FIG. 9).

Dashed lines are used in FIG. 9 to indicate that it is not required that the training manager 950 be embodied entirely in instructions 912, 914, and 944 at the same time. In one example, portions of the training manager 950 are embodied in instructions 914, which are read into main memory 904 as instructions 914, and portions of instructions 912 are read into processing device 902 as instructions 912 for execution. In another example, some portions of the training manager 950 are embodied in instructions 944 while other portions are embodied in instructions 914 and still other portions are embodied in instructions 912.

While the machine-readable storage medium 942 is shown in an example embodiment to be a single medium, the term “machine-readable storage medium” should be taken to include a single medium or multiple media that store the instructions. The term “machine-readable storage medium” shall also be taken to include any medium that is capable of storing or encoding a set of instructions for execution by the machine and that cause the machine to perform any of the methodologies of the present disclosure. The term “machine-readable storage medium” shall accordingly be taken to include, but not be limited to, solid-state memories, optical media, and magnetic media. The examples shown in FIG. 9 and the accompanying description above are provided for illustration purposes. This disclosure is not limited to the described examples.

Some portions of the preceding detailed description have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the computing system 100 or the computing system 700, can carry out the above-described computer-implemented methods in response to its processor executing a computer program (e.g., a sequence of instructions) contained in a memory or other non-transitory machine-readable storage medium (e.g., a non-transitory computer readable medium). Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities.

According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalisation tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

Additionally, as used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Illustrative examples of the technologies disclosed herein are provided below. An embodiment of the technologies may include any of the examples described herein, or any combination of any of the examples described herein, or any combination of any portions of the examples described herein.

In some aspects, the techniques described herein relate to a method including: generating, using a first large language model (LLM) and a domain-specific training content, an input of a set of input-output pairs, wherein the set of input-output pairs is used to train a second LLM during supervised learning to perform a downstream task; generating, using the first LLM and the domain-specific training content, an output corresponding to the input of the set of input-output pairs, wherein the output includes reasoning by the first LLM contributing to the performing of the downstream task; and training the second LLM to perform the downstream task using the set of input-output pairs and the reasoning.

In some aspects, the techniques described herein relate to a method, wherein the set of input-output pairs is a first set of input-output pairs and the downstream task is a classification task, further including: generating the first set of input-output pairs using a first prompt and the first LLM, wherein first prompt includes an instruction to classify an attribute based on the domain-specific training content, an instruction to generate a taxonomy based on the attribute, an instruction to identify a label of the domain-specific training content associated with the attribute and based on the taxonomy, and an instruction to provide a reasoning for the identified label, wherein the reasoning for the identified label is the reasoning by the first LLM contributing to the performing of the classification task.

In some aspects, the techniques described herein relate to a method, wherein the first prompt further includes an instruction to identify a null label associated with the domain-specific training content and the null label is associated with the attribute.

In some aspects, the techniques described herein relate to a method, wherein training the second LLM to perform the downstream task further includes: training the second LLM to identify the label of the domain-specific training content associated with the attribute and based on the taxonomy using the domain-specific training content, the attribute based on the domain-specific training content, and the taxonomy.

In some aspects, the techniques described herein relate to a method, wherein training the second LLM to perform the downstream task further includes: training the second LLM to provide the reasoning for the identified label.

In some aspects, the techniques described herein relate to a method, wherein the set of input-output pairs is a second set of input-output pairs and the downstream task is an entity extraction task, further including: generating the second set of input-output pairs using a second prompt and the first LLM, wherein the second prompt includes an instruction to identify a set of entities based on the domain-specific training content, and an instruction to identify a set of values corresponding to the set of entities.

In some aspects, the techniques described herein relate to a method, wherein the second prompt further includes an instruction to identify a null entity associated with the domain-specific training content and the null entity that is associated with the set of entities.

In some aspects, the techniques described herein relate to a method, wherein training the second LLM to perform the downstream task further includes: training the second LLM to identify the set of values corresponding to the set of entities based on the domain-specific training content using the domain-specific training content and the set of entities.

In some aspects, the techniques described herein relate to a method, wherein the set of input-output pairs is a third set of input-output pairs and the downstream task is a question and answer task, further including: generating the third set of input-output pairs using a third prompt and the first LLM, wherein the third prompt includes an instruction to generate a list of questions based on the domain-specific training content, an instruction to generate answers corresponding to questions of the list of questions, and an instruction to provide reasoning for each answer.

In some aspects, the techniques described herein relate to a method, wherein training the second LLM to perform the downstream task further includes: training the second LLM to generate answers corresponding to questions of the list of questions and further to provide reasoning for the generated answers using the domain-specific training content and the list of questions based on the domain-specific training content.

In some aspects, the techniques described herein relate to a method, wherein the set of input-output pairs is a fourth set of input-output pairs and the downstream task is a summarization task, further including: generating the fourth set of input-output pairs using a fourth prompt and the first LLM, wherein the fourth prompt includes an instruction to generate a set of guidelines based on the domain-specific training content and an instruction to generate a summary of the domain-specific training content, wherein the summary uses the set of guidelines.

In some aspects, the techniques described herein relate to a method, wherein training the second LLM to perform the downstream task further includes: training the second LLM to generate the summary using the domain-specific training content and the set of guidelines.

In some aspects, the techniques described herein relate to a system including: at least one processor; and at least one memory device coupled to the at least one processor, wherein the at least one memory device includes instructions that, when executed by the at least one processor, cause the at least one processor to perform at least one operation including: generating, using a first large language model (LLM) and a domain-specific training content, an input of a set of input-output pairs, wherein the set of input-output pairs is used to train a second LLM during supervised learning to perform a downstream task; generating, using the first LLM and the domain-specific training content, an output corresponding to the input of the set of input-output pairs, wherein the output includes reasoning by the first LLM contributing to the performing of the downstream task; and training the second LLM to perform the downstream task using the set of input-output pairs and the reasoning.

In some aspects, the techniques described herein relate to a system, wherein the set of input-output pairs is a first set of input-output pairs and the downstream task is a classification task, further including instructions that, when executed by the at least one processor, cause the at least one processor to perform at least one operation including: generating the first set of input-output pairs using a first prompt and the first LLM, wherein first prompt includes an instruction to classify an attribute based on the domain-specific training content, an instruction to generate a taxonomy based on the attribute, an instruction to identify a label of the domain-specific training content associated with the attribute and based on the taxonomy, and an instruction to provide a reasoning for the identified label, wherein the reasoning for the identified label is the reasoning by the first LLM contributing to the performing of the classification task.

In some aspects, the techniques described herein relate to a system, wherein the first prompt further includes an instruction to identify a null label associated with the domain-specific training content and the null label is associated with the attribute.

In some aspects, the techniques described herein relate to a system, wherein training the second LLM to perform the downstream task further includes instructions that, when executed by the at least one processor, cause the at least one processor to perform at least one operation including: training the second LLM to identify the label of the domain-specific training content associated with the attribute and based on the taxonomy using the domain-specific training content, the attribute based on the domain-specific training content, and the taxonomy.

In some aspects, the techniques described herein relate to a non-transitory machine-readable storage medium including instructions that, when executed by at least one processor, cause the at least one processor to perform at least one operation including: generating, using a first large language model (LLM) and a domain-specific training content, an input of a set of input-output pairs, wherein the set of input-output pairs is used to train a second LLM during supervised learning to perform a downstream task; generating, using the first LLM and the domain-specific training content, an output corresponding to the input of the set of input-output pairs, wherein the output includes reasoning by the first LLM contributing to the performing of the downstream task; and training the second LLM to perform the downstream task using the set of input-output pairs and the reasoning.

In some aspects, the techniques described herein relate to a non-transitory machine-readable storage medium, wherein the set of input-output pairs is a first set of input-output pairs and the downstream task is a classification task, further includes instructions that, when executed by at least one processor, cause the at least one processor to perform at least one operation including: generating the first set of input-output pairs using a first prompt and the first LLM, wherein first prompt includes an instruction to classify an attribute based on the domain-specific training content, an instruction to generate a taxonomy based on the attribute, an instruction to identify a label of the domain-specific training content associated with the attribute and based on the taxonomy, and an instruction to provide a reasoning for the identified label, wherein the reasoning for the identified label is the reasoning by the first LLM contributing to the performing of the classification task.

In some aspects, the techniques described herein relate to a non-transitory machine-readable storage medium, wherein the first prompt further includes an instruction to identify a null label associated with the domain-specific training content and the null label is associated with the attribute.

In some aspects, the techniques described herein relate to a non-transitory machine-readable storage medium, wherein training the second LLM to perform the downstream task further includes instructions that, when executed by at least one processor, cause the at least one processor to perform at least one operation including: training the second LLM to identify the label of the domain-specific training content associated with the attribute and based on the taxonomy using the domain-specific training content, the attribute based on the domain-specific training content, and the taxonomy.

Clause 1. A method comprising: generating, using a first large language model (LLM) and a domain-specific training content, an input of a set of input-output pairs, wherein the set of input-output pairs is used to train a second LLM during supervised learning to perform a downstream task; generating, using the first LLM and the domain-specific training content, an output corresponding to the input of the set of input-output pairs, wherein the output includes reasoning by the first LLM contributing to the performing of the downstream task; and training the second LLM to perform the downstream task using the set of input-output pairs and the reasoning.

Clause 2. The method of clause 1, wherein the set of input-output pairs is a first set of input-output pairs and the downstream task is a classification task, further comprising: generating the first set of input-output pairs using a first prompt and the first LLM, wherein first prompt comprises an instruction to classify an attribute based on the domain-specific training content, an instruction to generate a taxonomy based on the attribute, an instruction to identify a label of the domain-specific training content associated with the attribute and based on the taxonomy, and an instruction to provide a reasoning for the identified label, wherein the reasoning for the identified label is the reasoning by the first LLM contributing to the performing of the classification task.

Clause 3. The method of clause 1 or clause 2, wherein the first prompt further comprises an instruction to identify a null label associated with the domain-specific training content and the null label is associated with the attribute.

Clause 4. The method of any clauses 1-3, wherein training the second LLM to perform the downstream task further comprises: training the second LLM to identify the label of the domain-specific training content associated with the attribute and based on the taxonomy using the domain-specific training content, the attribute based on the domain-specific training content, and the taxonomy.

Clause 5. The method of any clauses 1-4, wherein training the second LLM to perform the downstream task further comprises: training the second LLM to provide the reasoning for the identified label.

Clause 6. The method of any clauses 1-5, wherein the set of input-output pairs is a second set of input-output pairs and the downstream task is an entity extraction task, further comprising: generating the second set of input-output pairs using a second prompt and the first LLM, wherein the second prompt comprises an instruction to identify a set of entities based on the domain-specific training content, and an instruction to identify a set of values corresponding to the set of entities.

Clause 7. The method of any clauses 1-6, wherein the second prompt further comprises an instruction to identify a null entity associated with the domain-specific training content and the null entity that is associated with the set of entities.

Clause 8. The method of any clauses 1-7, wherein training the second LLM to perform the downstream task further comprises: training the second LLM to identify the set of values corresponding to the set of entities based on the domain-specific training content using the domain-specific training content and the set of entities.

Clause 9. The method of any clauses 1-8, wherein the set of input-output pairs is a third set of input-output pairs and the downstream task is a question and answer task, further comprising: generating the third set of input-output pairs using a third prompt and the first LLM, wherein the third prompt comprises an instruction to generate a list of questions based on the domain-specific training content, an instruction to generate answers corresponding to questions of the list of questions, and an instruction to provide reasoning for each answer.

Clause 10. The method of any clauses 1-9, wherein training the second LLM to perform the downstream task further comprises: training the second LLM to generate answers corresponding to questions of the list of questions and further to provide reasoning for the generated answers using the domain-specific training content and the list of questions based on the domain-specific training content.

Clause 11. The method of any clauses 1-10, wherein the set of input-output pairs is a fourth set of input-output pairs and the downstream task is a summarization task, further comprising: generating the fourth set of input-output pairs using a fourth prompt and the first LLM, wherein the fourth prompt comprises an instruction to generate a set of guidelines based on the domain-specific training content and an instruction to generate a summary of the domain-specific training content, wherein the summary uses the set of guidelines.

Clause 12. The method of any clauses 1-11, wherein training the second LLM to perform the downstream task further comprises: training the second LLM to generate the summary using the domain-specific training content and the set of guidelines.

Clause 13. A system comprising: at least one processor; and at least one memory device coupled to the at least one processor, wherein the at least one memory device comprises instructions that, when executed by the at least one processor, cause the at least one processor to perform at least one operation comprising: generating, using a first large language model (LLM) and a domain-specific training content, an input of a set of input-output pairs, wherein the set of input-output pairs is used to train a second LLM during supervised learning to perform a downstream task; generating, using the first LLM and the domain-specific training content, an output corresponding to the input of the set of input-output pairs, wherein the output includes reasoning by the first LLM contributing to the performing of the downstream task; and training the second LLM to perform the downstream task using the set of input-output pairs and the reasoning.

Clause 14. The system of clause 13, wherein the set of input-output pairs is a first set of input-output pairs and the downstream task is a classification task, further comprising instructions that, when executed by the at least one processor, cause the at least one processor to perform at least one operation comprising: generating the first set of input-output pairs using a first prompt and the first LLM, wherein first prompt comprises an instruction to classify an attribute based on the domain-specific training content, an instruction to generate a taxonomy based on the attribute, an instruction to identify a label of the domain-specific training content associated with the attribute and based on the taxonomy, and an instruction to provide a reasoning for the identified label, wherein the reasoning for the identified label is the reasoning by the first LLM contributing to the performing of the classification task.

Clause 15. The system of clause 14 or clause 13, wherein the first prompt further comprises an instruction to identify a null label associated with the domain-specific training content and the null label is associated with the attribute.

Clause 16. The system of any clauses 13-15, wherein training the second LLM to perform the downstream task further comprises instructions that, when executed by the at least one processor, cause the at least one processor to perform at least one operation comprising: training the second LLM to identify the label of the domain-specific training content associated with the attribute and based on the taxonomy using the domain-specific training content, the attribute based on the domain-specific training content, and the taxonomy.

Clause 17. A non-transitory machine-readable storage medium comprising instructions that, when executed by at least one processor, cause the at least one processor to perform at least one operation comprising: generating, using a first large language model (LLM) and a domain-specific training content, an input of a set of input-output pairs, wherein the set of input-output pairs is used to train a second LLM during supervised learning to perform a downstream task; generating, using the first LLM and the domain-specific training content, an output corresponding to the input of the set of input-output pairs, wherein the output includes reasoning by the first LLM contributing to the performing of the downstream task; and training the second LLM to perform the downstream task using the set of input-output pairs and the reasoning.

Clause 18. The non-transitory machine-readable storage medium of clause 17, wherein the set of input-output pairs is a first set of input-output pairs and the downstream task is a classification task, further comprises instructions that, when executed by at least one processor, cause the at least one processor to perform at least one operation comprising: generating the first set of input-output pairs using a first prompt and the first LLM, wherein first prompt comprises an instruction to classify an attribute based on the domain-specific training content, an instruction to generate a taxonomy based on the attribute, an instruction to identify a label of the domain-specific training content associated with the attribute and based on the taxonomy, and an instruction to provide a reasoning for the identified label, wherein the reasoning for the identified label is the reasoning by the first LLM contributing to the performing of the classification task.

Clause 19. The non-transitory machine-readable storage medium of clause 18 or clause 17, wherein the first prompt further comprises an instruction to identify a null label associated with the domain-specific training content and the null label is associated with the attribute.

Clause 20. The non-transitory machine-readable storage medium of any clauses 17-19, wherein training the second LLM to perform the downstream task further comprises instructions that, when executed by at least one processor, cause the at least one processor to perform at least one operation comprising: training the second LLM to identify the label of the domain-specific training content associated with the attribute and based on the taxonomy using the domain-specific training content, the attribute based on the domain-specific training content, and the taxonomy.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method comprising:
generating, using a first large language model (LLM) and a domain-specific training content, an input of a set of input-output pairs, wherein the set of input-output pairs is used to train a second LLM during supervised learning to perform a downstream task;
generating, using the first LLM and the domain-specific training content, an output corresponding to the input of the set of input-output pairs, wherein the output includes reasoning by the first LLM contributing to the performing of the downstream task; and
training the second LLM to perform the downstream task using the set of input-output pairs and the reasoning.

2. The method of claim 1, wherein the set of input-output pairs is a first set of input-output pairs and the downstream task is a classification task, further comprising:
generating the first set of input-output pairs using a first prompt and the first LLM, wherein first prompt comprises an instruction to classify an attribute based on the domain-specific training content, an instruction to generate a taxonomy based on the attribute, an instruction to identify a label of the domain-specific training content associated with the attribute and based on the taxonomy, and an instruction to provide a reasoning for the identified label, wherein the reasoning for the identified label is the reasoning by the first LLM contributing to the performing of the classification task.

3. The method of claim 2, wherein the first prompt further comprises an instruction to identify a null label associated with the domain-specific training content and the null label is associated with the attribute.

4. The method of claim 2, wherein training the second LLM to perform the downstream task further comprises:
training the second LLM to identify the label of the domain-specific training content associated with the attribute and based on the taxonomy using the domain-specific training content, the attribute based on the domain-specific training content, and the taxonomy.

5. The method of claim 4, wherein training the second LLM to perform the downstream task further comprises:
training the second LLM to provide the reasoning for the identified label.

6. The method of claim 1, wherein the set of input-output pairs is a second set of input-output pairs and the downstream task is an entity extraction task, further comprising:
generating the second set of input-output pairs using a second prompt and the first LLM, wherein the second prompt comprises an instruction to identify a set of entities based on the domain-specific training content, and an instruction to identify a set of values corresponding to the set of entities.

7. The method of claim 6, wherein the second prompt further comprises an instruction to identify a null entity associated with the domain-specific training content and the null entity that is associated with the set of entities.

8. The method of claim 6, wherein training the second LLM to perform the downstream task further comprises:
training the second LLM to identify the set of values corresponding to the set of entities based on the domain-specific training content using the domain-specific training content and the set of entities.

9. The method of claim 1, wherein the set of input-output pairs is a third set of input-output pairs and the downstream task is a question-and-answer task, further comprising:
generating the third set of input-output pairs using a third prompt and the first LLM, wherein the third prompt comprises an instruction to generate a list of questions based on the domain-specific training content, an instruction to generate answers corresponding to questions of the list of questions, and an instruction to provide reasoning for each answer.

10. The method of claim 9, wherein training the second LLM to perform the downstream task further comprises:
training the second LLM to generate answers corresponding to questions of the list of questions and further to provide reasoning for the generated answers using the domain-specific training content and the list of questions based on the domain-specific training content.

11. The method of claim 1, wherein the set of input-output pairs is a fourth set of input-output pairs and the downstream task is a summarization task, further comprising:
generating the fourth set of input-output pairs using a fourth prompt and the first LLM, wherein the fourth prompt comprises an instruction to generate a set of guidelines based on the domain-specific training content and an instruction to generate a summary of the domain-specific training content, wherein the summary uses the set of guidelines.

12. The method of claim 11, wherein training the second LLM to perform the downstream task further comprises:
training the second LLM to generate the summary using the domain-specific training content and the set of guidelines.

13. A system comprising:
at least one processor; and
at least one memory device coupled to the at least one processor, wherein the at least one memory device comprises instructions that, when executed by the at least one processor, cause the at least one processor to perform at least one operation comprising:
generating, using a first large language model (LLM) and a domain-specific training content, an input of a set of input-output pairs, wherein the set of input-output pairs is used to train a second LLM during supervised learning to perform a downstream task;
generating, using the first LLM and the domain-specific training content, an output corresponding to the input of the set of input-output pairs, wherein the output includes reasoning by the first LLM contributing to the performing of the downstream task; and
training the second LLM to perform the downstream task using the set of input-output pairs and the reasoning.

14. The system of claim 13, wherein the set of input-output pairs is a first set of input-output pairs and the downstream task is a classification task, further comprising instructions that, when executed by the at least one processor, cause the at least one processor to perform at least one operation comprising:
generating the first set of input-output pairs using a first prompt and the first LLM, wherein first prompt comprises an instruction to classify an attribute based on the domain-specific training content, an instruction to generate a taxonomy based on the attribute, an instruction to identify a label of the domain-specific training content associated with the attribute and based on the taxonomy, and an instruction to provide a reasoning for the identified label, wherein the reasoning for the identified label is the reasoning by the first LLM contributing to the performing of the classification task.

15. The system of claim 14, wherein the first prompt further comprises an instruction to identify a null label associated with the domain-specific training content and the null label is associated with the attribute.

16. The system of claim 14, wherein training the second LLM to perform the downstream task further comprises instructions that, when executed by the at least one processor, cause the at least one processor to perform at least one operation comprising:
training the second LLM to identify the label of the domain-specific training content associated with the attribute and based on the taxonomy using the domain-specific training content, the attribute based on the domain-specific training content, and the taxonomy.

17. A non-transitory machine-readable storage medium comprising instructions that, when executed by at least one processor, cause the at least one processor to perform at least one operation comprising:
generating, using a first large language model (LLM) and a domain-specific training content, an input of a set of input-output pairs, wherein the set of input-output pairs is used to train a second LLM during supervised learning to perform a downstream task;
generating, using the first LLM and the domain-specific training content, an output corresponding to the input of the set of input-output pairs, wherein the output includes reasoning by the first LLM contributing to the performing of the downstream task; and
training the second LLM to perform the downstream task using the set of input-output pairs and the reasoning.

18. The non-transitory machine-readable storage medium of claim 17, wherein the set of input-output pairs is a first set of input-output pairs and the downstream task is a classification task, further comprises instructions that, when executed by at least one processor, cause the at least one processor to perform at least one operation comprising:
generating the first set of input-output pairs using a first prompt and the first LLM, wherein first prompt comprises an instruction to classify an attribute based on the domain-specific training content, an instruction to generate a taxonomy based on the attribute, an instruction to identify a label of the domain-specific training content associated with the attribute and based on the taxonomy, and an instruction to provide a reasoning for the identified label, wherein the reasoning for the identified label is the reasoning by the first LLM contributing to the performing of the classification task.

19. The non-transitory machine-readable storage medium of claim 18, wherein the first prompt further comprises an instruction to identify a null label associated with the domain-specific training content and the null label is associated with the attribute.

20. The non-transitory machine-readable storage medium of claim 18, wherein training the second LLM to perform the downstream task further comprises instructions that, when executed by at least one processor, cause the at least one processor to perform at least one operation comprising:
training the second LLM to identify the label of the domain-specific training content associated with the attribute and based on the taxonomy using the domain-specific training content, the attribute based on the domain-specific training content, and the taxonomy.
